(19) United States
(12) Patent Application Publication
(10) Pub. No.: US 2018/0116005 A1
(43) Pub. Date: Apr. 26, 2018

(54) DATA DOWNLOAD HANDOVER FROM DEVICE TO DEVICE

(71) Applicant: QUALCOMM Incorporated, San Diego, CA (US)

(72) Inventors: AnkammaRao Ravuvari, Hyderabad (IN); Syam Pavan Vadapalli, Visakhapatnam (IN); Venkata Srihari Inampudi, Hyderabad (IN); Parshu Ramulu Chintakindi, Hyderabad (IN)

(21) Appl. No.: 15/335,097

(22) Filed: Oct. 26, 2016

(51) Int. Cl. H04W 76/02; H04W 36/38

(52) U.S. Cl. CPC H04W 76/028; H04W 36/385

(57) ABSTRACT

Methods, systems, and devices for wireless communication are described. A mobile device may receive a portion of a data file for a download prior to identifying a condition that interrupts the download. A download handover request identifying the data file that has been partially downloaded and requesting a continuation of a data download at a target device may be sent to a network node. The remaining portion of the data file may then continue to be downloaded at the target device of a home network based on the interruption condition (e.g., via a download continuation request containing information identifying the partially-downloaded data file, sent to the target device from the network node). A communication session with the mobile device in the home network may then be established, and the remaining portion of the data file may be transmitted to the mobile device from the target device.

### BACKGROUND

The present disclosure relates generally to wireless communication, and more specifically to data download handover from device to device.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

A UE may download data over a network connection (e.g., through an access point). In some cases, a UE may be unable to complete a download (e.g., download all data associated with a particular data file) based on a number of factors. For example, low battery, data constraints (e.g., running out of data in the user's data package before completing the download), low-speed internet connection, low memory of the mobile device, user operated services that conflict with the current download, etc. may stop an active download. These situations may require that the user cancel or otherwise abort the download, and reinitiate the download at a later time. Reinitiating the download may result in inefficiencies. For example, a UE may download the same portions of data twice, using additional resources, and wasting resources that had already been used. The wasted resources may include data of the user's data plan, time spent waiting for the data download, and battery power for the mobile device.

### SUMMARY

The described techniques relate to improved methods, systems, devices, or apparatuses that support data download handover from device to device. Generally, the described techniques provide for a mobile device to identify a data file for a data download in a serving wireless network, and handover the download to a target device in a home network if the download is interrupted in the serving wireless network. The target device may then download a remaining portion of the data file for the data download. The mobile device may have downloaded a first portion of the data file, such that the remaining portion of the data file is a second portion of the data file, or the remaining portion may be the complete data file. Later, when the mobile device returns to the home network, the mobile device may establish a communication session with the target device, directly through a peer-to-peer connection or indirectly through an access point (AP), to retrieve the remaining portion of the data file. The mobile device may then receive the remaining portion of the data file from the target device. Where the mobile device had previously downloaded a first portion of the data file, the mobile device may combine the remaining portion of the data file with the first portion of the data file to form a complete data file.

To communicate to the target device that it should download the remaining portion of the data file, the mobile device may transmit a download handover request to the serving wireless network. The download handover request identifies the data file to be downloaded by the target device. A network node, for example in the core network of the serving wireless network, may maintain a database or registry of associations between mobile devices and target devices, which may each be assigned a priority. A user, for example using the mobile device, may have previously generated a registration request including target devices associated with the mobile device that is sent to the network node. The network node may select a highest-priority target device that is available to which to send a download continuation request. The download continuation request may include metadata (obtained from the download handover request from the mobile device) associated with the data file to be downloaded, including a file name, number of bytes downloaded, and internet protocol (IP) address of the server serving the data file. Status messages regarding the success or failure of the download handover may be sent from the target device to the mobile device in the serving wireless network through the network node.

A method of wireless communication is described. The method may include identifying, at the mobile device in a serving wireless network, a data file for a data download, identifying a condition interrupting the data download at the mobile device, determining to download a remaining portion of the data file at a target device of a home network based at least in part on identifying the condition, and transmitting, to the serving wireless network, a download handover request that identifies the data file to be downloaded by the target device.

An apparatus for wireless communication is described. The apparatus may include means for identifying, at the mobile device in a serving wireless network, a data file for a data download, means for identifying a condition interrupting the data download at the mobile device, means for determining to download a remaining portion of the data file at a target device of a home network based at least in part on identifying the condition, and means for transmitting, to the serving wireless network, a download handover request that identifies the data file to be downloaded by the target device.

Another apparatus for wireless communication is described. The apparatus may include a memory that stores instructions, and a processor coupled with the memory. The processor and the memory may be configured to identify, at the mobile device in a serving wireless network, a data file for a data download, identify a condition interrupting the data download at the mobile device, determine to download a remaining portion of the data file at a target device of a home network based at least in part on identifying the condition, and transmit, to the serving wireless network, a download handover request that identifies the data file to be downloaded by the target device.

A non-transitory computer readable medium for wireless communication is described. The non-transitory computer-readable medium may include instructions operable to cause a processor to identify, at the mobile device in a serving wireless network, a data file for a data download, identify a condition interrupting the data download at the mobile device, determine to download a remaining portion of the data file at a target device of a home network based at least in part on identifying the condition, and transmit, to the serving wireless network, a download handover request that identifies the data file to be downloaded by the target device.

Some examples of the method, apparatus, and non-transitory computer-readable medium described above may further include processes, features, means, or instructions for establishing a communication session with the target device in the home network and receiving the remaining portion of the data file from the target device.

In some examples of the method, apparatus, and non-transitory computer-readable medium described above, the remaining portion of the data file comprises a complete data file. Some examples of the method, apparatus, and non-transitory computer-readable medium described above may further include processes, features, means, or instructions for selecting, from among a set of target devices, the target device to download the remaining portion of the data file.

Some examples of the method, apparatus, and non-transitory computer-readable medium described above may further include processes, features, means, or instructions for identifying one or more target devices to receive download handovers in the home network for the mobile device, wherein the one or more target devices comprise the target device. Some examples of the method, apparatus, and non-transitory computer-readable medium described above may further include processes, features, means, or instructions for transmitting, to the serving wireless network, a registration request for the serving wireless network to associate the mobile device with the one or more target devices.

Some examples of the method, apparatus, and non-transitory computer-readable medium described above may further include processes, features, means, or instructions for assigning a priority to each of the respective one or more target devices, wherein the registration request further comprises the assigned priorities.

In some examples of the method, apparatus, and non-transitory computer-readable medium described above, identifying the condition interrupting the data download comprises: receiving a user command for the mobile device to perform a download handover. Some examples of the method, apparatus, and non-transitory computer-readable medium described above may further include processes, features, means, or instructions for determining that an amount of data used by the mobile device may have exceeded a predetermined data usage threshold. Some examples of the method, apparatus, and non-transitory computer-readable medium described above may further include processes, features, means, or instructions for determining that an amount of available storage of the mobile device may have fallen below a predetermined storage threshold. Some examples of the method, apparatus, and non-transitory computer-readable medium described above may further include processes, features, means, or instructions for determining that a transmission capacity for the mobile device may have fallen below a predetermined capacity threshold. Some examples of the method, apparatus, and non-transitory computer-readable medium described above may further include processes, features, means, or instructions for determining that a shutdown procedure for the mobile device may have been initiated. Some examples of the method, apparatus, and non-transitory computer-readable medium described above may further include processes, features, means, or instructions for determining that a battery level of the mobile device may be less than a predetermined battery level threshold.

Some examples of the method, apparatus, and non-transitory computer-readable medium described above may further include processes, features, means, or instructions for transmitting the download handover request in a radio resource control (RRC) message to the serving wireless network.

In some examples of the method, apparatus, and non-transitory computer-readable medium described above, the serving wireless network comprises a wireless wide area network (WWAN). In some examples of the method, apparatus, and non-transitory computer-readable medium described above, the home network comprises a wireless local area network (WLAN) or a WWAN.

A method of wireless communication is described. The method may include receiving, from a network node of a communications network, a download continuation request that requests that the target device in a home network download a remaining portion of a data file for a mobile device, wherein the download continuation request comprises information identifying the data file, downloading, to the target device, the remaining portion of the data file based at least in part on the information identifying the data file, establishing a communication session with the mobile device in the home network, and transmitting the remaining portion of the data file to the mobile device.

An apparatus for wireless communication is described. The apparatus may include means for receiving, from a network node of a communications network, a download continuation request that requests that the target device in a home network download a remaining portion of a data file for a mobile device, wherein the download continuation request comprises information identifying the data file, means for downloading, to the target device, the remaining portion of the data file based at least in part on the information identifying the data file, means for establishing a communication session with the mobile device in the home network, and means for transmitting the remaining portion of the data file to the mobile device.

Another apparatus for wireless communication is described. The apparatus may include a memory that stores instructions, and a processor coupled with the memory. The processor and the memory may be configured to receive, from a network node of a communications network, a download continuation request that requests that the target device in a home network download a remaining portion of a data file for a mobile device, wherein the download continuation request comprises information identifying the data file, download, to the target device, the remaining portion of the data file based at least in part on the information identifying the data file, establish a communication session with the mobile device in the home network, and transmit the remaining portion of the data file to the mobile device.

A non-transitory computer readable medium for wireless communication is described. The non-transitory computer-readable medium may include instructions operable to cause a processor to receive, from a network node of a communications network, a download continuation request that requests that the target device in a home network download a remaining portion of a data file for a mobile device, wherein the download continuation request comprises information identifying the data file, download, to the target device, the remaining portion of the data file based at least in part on the information identifying the data file, establish a communication session with the mobile device in the home network, and transmit the remaining portion of the data file to the mobile device.

Some examples of the method, apparatus, and non-transitory computer-readable medium described above may further include processes, features, means, or instructions for transmitting, to the network node, a request to transmit the remaining portion of the data file based at least in part on receiving the download continuation request. Some examples of the method, apparatus, and non-transitory computer-readable medium described above may further include processes, features, means, or instructions for downloading the remaining portion of the data file from the network node.

In some examples of the method, apparatus, and non-transitory computer-readable medium described above, the download continuation request comprises a download handover paging message.

In some examples of the method, apparatus, and non-transitory computer-readable medium described above, the download handover paging message comprises metadata associated with the data file.

In some examples of the method, apparatus, and non-transitory computer-readable medium described above, establishing the communication session with the mobile device comprises: establishing a wireless peer-to-peer file transfer session between the mobile device and the target device.

In some examples of the method, apparatus, and non-transitory computer-readable medium described above, the apparatus is a wireless communication terminal and further comprises an antenna and a transceiver.

### BRIEF DESCRIPTION OF THE DRAWINGS

FIG. 1 illustrates an example of a system for wireless communication that supports data download handover from device to device in accordance with aspects of the present disclosure.

FIG. 2 illustrates an example of a system for wireless communication that supports data download handover from device to device in accordance with aspects of the present disclosure.

FIG. 3 illustrates an example of a system for wireless communication that supports data download handover from device to device in accordance with aspects of the present disclosure.

FIG. 4 illustrates an example of a process flow that supports data download handover from device to device in accordance with aspects of the present disclosure.

FIG. 5 illustrates an example of a process flow that supports data download handover from device to device in accordance with aspects of the present disclosure.

FIG. 6 illustrates an example of a process flow that supports data download handover from device to device in accordance with aspects of the present disclosure.

FIG. 7 illustrates an example of a process flow that supports data download handover from device to device in accordance with aspects of the present disclosure.

FIGS. 8 through 10 show block diagrams of a device that supports data download handover from device to device in accordance with aspects of the present disclosure.

FIG. 11 illustrates a block diagram of a system including a user equipment (UE) that supports data download handover from device to device in accordance with aspects of the present disclosure.

FIGS. 12 through 14 show block diagrams of a device that supports data download handover from device to device in accordance with aspects of the present disclosure.

FIG. 15 illustrates a block diagram of a system including a network node that supports data download handover from device to device in accordance with aspects of the present disclosure.

FIGS. 16 through 18 show block diagrams of a device that supports data download handover from device to device in accordance with aspects of the present disclosure.

FIG. 19 illustrates a block diagram of a system including a station (STA) that supports data download handover from device to device in accordance with aspects of the present disclosure.

FIGS. 20 through 22 illustrate methods for data download handover from device to device in accordance with aspects of the present disclosure.

### DETAILED DESCRIPTION

A wireless communication system may support services that allow a user equipment (UE) to download content (e.g., music files, video files, etc.) over a network connection (e.g., through a base station) from servers or other content providers accessible through the internet. In some cases, the UE may be unable to complete the download of the content based on one or more of a number of reasons. For example, the UE may have a low battery and will soon turn off or enter a sleep state. A user may have run out of available data, or may soon run out of available data, in the user's data plan or package, for example before the download can complete. The UE may have begun the download when a higher-speed connection was available, but the UE has since moved to an area in which a lower-speed connection is available. In other examples, channel conditions may have changed for other reasons such as changing weather or movement of objects around the UE or base station. In some examples, a UE may determine that it has low memory such that it is not desirable or not possible to complete the download. The UE may also stop an active download where other services conflict with the current download. These situations may result in the download being halted or canceled, and the portion of the data downloaded by the UE lost, such that the UE may need to later reinitiate the download, redownloading the same first portion of the data download that was previously downloaded by the UE, in addition to the remaining portion of the download. Restarting the download may waste the additional time, battery power, and data plan usage that were already expended downloading the first portion of the download.

Techniques are described for handover of data downloads from one device to another device. The download handover may be from a mobile device to a target device of a home network, where the home network may be, for example, an internet of things (IoT) network, a wireless local area network (WLAN), a wireless wide area network (WWAN), etc. The user of the mobile device may initiate a data download in a first network (e.g., in a WWAN using LTE or other cellular technology) that serves the mobile device through a base station or access point. The mobile device may then stop the download prior to completing the download, for example before a first portion of the data file is downloaded to the mobile device, or after a first portion of the data file has been downloaded, but prior to completion of the download. Criteria used to determine to stop the download may be determined automatically or in response to input from a user. In some examples, the criteria may include predetermined thresholds based on battery life, data plan, storage capacity, download speed, signal strength, and signal quality. In some cases, the mobile device may request that the remainder of the download (e.g., after download stoppage) be completed by a device in a home network.

The mobile device may send a message to a network node of its source network requesting a download handover. For example, the mobile device may send a radio resource control (RRC) signaling message to the core network of a WWAN via one or more network nodes of the WWAN serving the mobile device (e.g., a base station, eNodeB, radio network controller (RNC), etc.). The RRC signaling message may indicate a request for the source network to initiate a download handover procedure to a target device of a home network. The request may be sent in a measurement report or an RRC connection release message. The request from the RRC signaling message may be passed to the core network of the source network. The core network may then determine the target device of the home network and attempt to establish a connection with the target device.

The core network may then determine the target device of the home network. In some examples, the network node may maintain a database of registered target devices and/or their associated networks. Upon receiving the RRC signaling message, the network node may determine the target device and/or network associated with the mobile device from the database. Target devices may be assigned priority levels by a user when registering a target device with the source network, such that the core network may select the target device with a highest priority level when multiple target devices are available for a particular mobile device. The core network may attempt to establish a connection with the selected target device. If the first attempt at connection is not successful, the network may select another target device according to the target device priority levels, or if no connection is successful, the core network may send the mobile device a message indicating failure of the download handover.

If a successful connection to the target device is established, the core network may send the remaining portion of the download (e.g., the second portion of the data following download stoppage, or the complete data file) to the target device of the home network. The core network may then send a message to the mobile device indicating that the download handover to the target device was successful. After completing the download of the second portion of the data, the target device may store the remaining portion of the data until the mobile device connects to the home network. Once the mobile device connects to the home network, the mobile device may receive the remaining portion of the downloaded data from the target device using, for example Bluetooth, Wi-Fi direct, etc.

The mobile device may contain an application or additional functionality that enables the user to register devices with the data handover service. The same application may allow a user to select a target device for a data handover, select a priority level for a target device, and/or establish the criteria or predetermined thresholds to be used to initiate the data download handover.

Aspects of the disclosure are initially described in the context of a wireless communications system. Examples of wireless communication systems supporting download handover in addition to example process flows of such handovers are then described. Aspects of the disclosure are further illustrated by and described with reference to apparatus diagrams, system diagrams, and flowcharts that relate to data download handover from device to device.

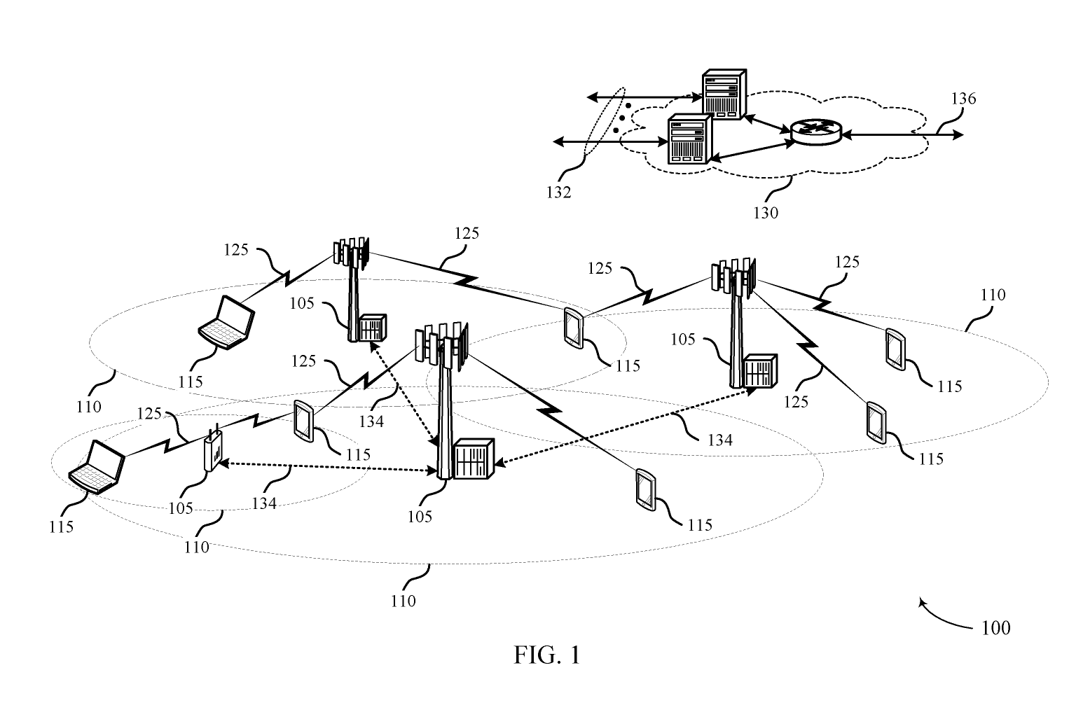

FIG. 1 shows an example of a wireless communication system 100, in accordance with various aspects of the present disclosure. The wireless communication system 100 may include base stations 105, UEs 115, and a core network 130. The core network 130 may provide user authentication, access authorization, tracking, Internet Protocol (IP) connectivity, and other access, routing, or mobility functions. The core network 130 may interface with the internet through an internet link 136 and may communicate with other networks directly or indirectly, for example through the internet. Base stations 105 may interface with the core network 130 through backhaul links 132 (e.g., S1, etc.) and may perform radio configuration and scheduling for communication with the UEs 115, or may operate under the control of a base station controller. The base stations 105 may be grouped and connected to a radio network controller (RNC) that may manage communication between the base stations 105 and the core network 130. The RNC may also manage handover procedures and communicate with UEs 115 to coordinate handovers. In various examples, the base stations 105 may communicate, either directly or indirectly (e.g., through core network 130), with each other over backhaul links 134 (e.g., X2, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, a base station 105 may be referred to as a base transceiver station, a radio base station, an access point, a radio transceiver, a NodeB, an eNodeB (eNB), a Home NodeB, a Home eNodeB, or some other suitable terminology. The geographic coverage area 110 for a base station 105 may be divided into sectors making up a portion of the coverage area. The wireless communication system 100 may include base stations 105 of different types (e.g., macro or small cell base stations). There may be overlapping geographic coverage areas 110 for different technologies.

In some examples, the wireless communication system 100 may include an LTE/LTE-A network (e.g., technology using licensed spectrum LTE protocols or versions of LTE protocols customized for use wholly or partially in the unlicensed spectrum) and may employ narrow-band communication techniques, as described below. In LTE/LTE-A networks, the term evolved Node B (eNB) may be used to describe the base stations 105. The wireless communication system 100 may be a Heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., licensed, shared, etc.) radio frequency spectrum bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

Devices in wireless communication system 100 may communicate over unlicensed spectrum, which may be a portion of spectrum that includes frequency bands traditionally used by Wi-Fi technology (e.g., technology using IEEE 802.11 communication protocols), such as the 5 GHz band, the 2.4 GHz band, the 60 GHz band, the 3.6 GHz band, and/or the 900 MHz band. The unlicensed spectrum may also include other frequency bands.

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, a NB-LTE device, a M2M device, a machine type communication (MTC) device, an enhanced MTC (eMTC) device, a NB-Internet of Things (IoT) device or the like. MTC devices, eMTC devices, and NB-IoT devices may represent devices that communicate at relatively low data rates or in low signal to noise ratio (SNR) environments. A UE may be able to communicate with various types of base stations and network equipment, including macro eNBs, small cell eNBs, relay base stations, and the like.

The communication links 125 shown in wireless communication system 100 may include downlink (DL) transmissions, from a base station 105 to a UE 115, or uplink (UL) transmissions, from a UE 115 to a base station 105. The downlink transmissions may also be called forward link transmissions, while the uplink transmissions may also be called reverse link transmissions. The communication links 125 may include, for example, resources for wide-band physical control channels (e.g., a physical downlink control channel (PDCCH) or enhanced PDCCH (ePDCCH)), wide-band downlink data channels (e.g., a physical downlink shared channel (PDSCH)), narrow-band physical control channels (e.g., a narrow-band PDCCH (NB-PDCCH)), and narrow-band downlink data channels (e.g., an NB-PDSCH).

In some examples, each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using a frequency division duplexing (FDD) operation (e.g., using paired spectrum resources) or a time division duplexing (TDD) operation (e.g., using unpaired spectrum resources). Frame structures for FDD operation (e.g., frame structure type 1) and TDD operation (e.g., frame structure type 2) may be defined.

In some cases, a mobile device (e.g., UE 115), may be used to download content (e.g., music files, movie files, etc.) from a serving wireless network (e.g., wireless communication system 100, etc.) or from another network or server accessible in or via the serving wireless network through base station 105. After identifying a data file for a data download from the wireless communication system 100, the UE 115 may identify a condition interrupting the data download at the mobile device. In some examples, the UE 115 may download a remaining portion of the data file at a target device of a home network for the UE 115. In some cases, the remaining portion of the data file may include the complete data file. In other case, UE 115 may download a first portion of the data file and the remaining portion of the data file may be a second portion of the data file. The UE 115 may transmit a download handover request to the wireless communication system 100. The download handover request may identify the data file to be downloaded by the target device of the home network and request a continuation of a data download for the remaining data file (e.g., the remainder of the partially-downloaded file). A network node (e.g., a network node in the core network 130 of wireless communication system 100) may receive the download handover request and identify the target device. The network node may then transmit a download continuation request to the target device, the download continuation request requesting that the target device download the remaining portion of the data file in the home network for later retrieval by UE 115.

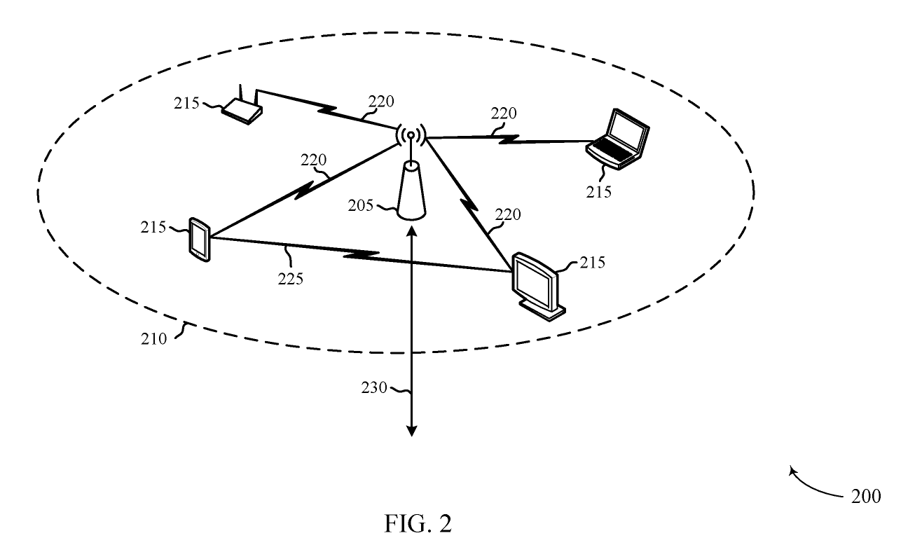

FIG. 2 illustrates an example of a wireless local area network (WLAN) 200. The WLAN 200 may include an access point (AP) 205 and wireless devices or STAs 215, such as mobile stations, phones, personal digital assistants (PDAs), other handheld devices, netbooks, notebook computers, tablet computers, laptops, display devices (e.g., TVs, computer monitors, etc.), printers, etc. While only one AP 205 is illustrated, WLAN 200 may have multiple APs 205. Each of the STAs 215, which may also be referred to as mobile stations (MSs), mobile devices, access terminals (ATs), UE, subscriber stations (SSs), or subscriber units, may associate and communicate with an AP 205 via a communication link 220. As used herein, a mobile device may refer to a device that may be both a UE 115 and STA 215, depending on the wireless network with which the mobile device is interacting (e.g., the mobile device may be a UE 115 when interacting with wireless communication system 100 and may be a STA 215 when interacting with WLAN 200).

Communication link 220 may provide wireless communications using more than one RF band. Each AP 205 may have a geographic coverage area 210 such that STAs 215 within that area can typically communicate with the AP 205. The AP 205 and WLAN 200 may interface with the internet through a network communication link 230 and may communicate with other networks, servers, and other network nodes and devices accessible via the internet (e.g., via one or more internet service providers), through the network communication link 230. The STAs 215 may be dispersed throughout the geographic coverage area 210. Each STA 215 may be stationary or mobile.

Although not shown in FIG. 2, a STA 215 can be covered by more than one AP 205 and can therefore associate with APs 205 at different times. A single AP 205 and an associated set of stations may be referred to as a basic service set (BSS). An extended service set (ESS) is a set of connected BSSs. A distribution system (DS) may be used to connect APs 205 in an ESS. A geographic coverage area 210 for an AP 205 may be divided into sectors making up only a portion of the coverage area. The WLAN 200 may include APs 205 of different types, with varying sizes of coverage areas and overlapping coverage areas for different technologies. Although not shown, other wireless devices can communicate with the AP 205.

While the STAs 215 may communicate with each other through the AP 205 using communication links 220, each STA 215 may also communicate directly with other STAs 215 via a direct wireless link 225. Two or more STAs 215 may communicate via a direct wireless link 225 when both STAs 215 are in the AP geographic coverage area 210 or when one or neither STA 215 is within the AP geographic coverage area 210. Examples of direct wireless links 225 may include Wi-Fi Direct connections, connections established by using a Wi-Fi Tunneled Direct Link Setup (TDLS) link, and other P2P group connections. The STAs 215 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, 802.11ax, etc. In other implementations, other peer-to-peer connections or ad hoc networks may be implemented within WLAN 200.

As described above with reference to FIG. 1, a STA 215 (e.g., a mobile device that may also be a UE 115) may be used to download content (e.g., music files, movie files, etc.) from a serving wireless network. After identifying content to download to the mobile device, the download may be interrupted, for example after a first portion of the data file has been downloaded. Later reinitiating the download may result in the first portion of the downloaded content being lost. As such, WLAN 200 may support techniques for redirecting the download of a remaining portion of content from a mobile device to a target device (e.g., a STA 215 or AP 205) in a home network (e.g., WLAN 200). The target device may receive a download continuation request from a network node via network communication link 230. The target device may then identify a partially-downloaded data file or the remaining data file in the download continuation request and download the remaining portion of the data file. Subsequently, the mobile device may establish a communication session with the target device in the home network and transmit the remaining portion of the data file to the mobile device. The communication session may be direct (e.g., direct wireless links 225 between two STAs 215) or indirect (e.g., through an AP 205 via communication links 220).

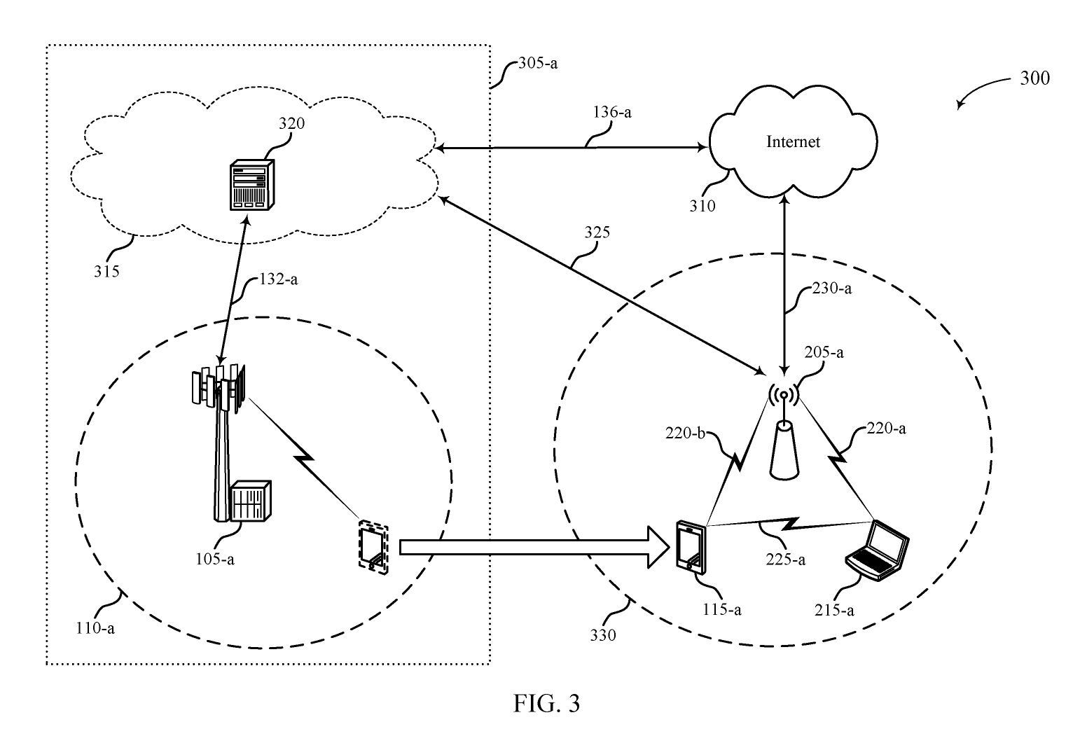

FIG. 3 shows a diagram of a wireless communications system 300 illustrating an example of data download handover, in accordance with various aspects of the present disclosure. Wireless communications system 300 may include a source network 305-a and a home network 330. Source network 305-a may be or include aspects of wireless communication system 100. In some cases, home network 330 may be or include aspects of WLAN 200. In other cases, home network 330 may be or include aspects of wireless communication system 100 (e.g., a WWAN). Source network 305-a may communicate with home network 330 through internet 310 via internet link 136-a and network communication link 230-a. In other examples, internet 310 may include other aspects of or be a different packet switched network. In some examples, home network 330 and WLAN 200 (or wireless communication system 100) may communicate directly through communication link 325. In some examples, communication link 325 may be a communication link using an S2a interface.

Source network 305-a may include a UE 115-a in communication with a base station 105-a. Base station 105-a may have a coverage area 110-a, and UE 115-a may be located within the coverage area 110-a. Source network 305-a may also include network architecture 315 that may include aspects of the core network 130 described with reference to FIG. 1. Network architecture 315 may include a network node 320 which may communicate with base station 105-a via a backhaul link 132-a (e.g., S1, etc.). In some cases, the network architecture 315 may include one or more of a home subscriber server (HSS), a mobility management entity (MME), a serving gateway (S-GW), and a packet data network (PDN) gateway (P-GW). The HSS may include information about a network operator's subscribers such as the amount of data in a subscriber's data package. The MME may be responsible for managing radio resources and network access control for UE 115-a. The S-GW may communicate with base station 105-a or network node 320 and relay information from base station 105-a or network node 320 to the P-GW. The P-GW may serve as a gateway to source network 305-a directly via, for example, communication link 325 or indirectly (e.g., through internet 310 via, for example, internet link 136-a and network communication link 230-a.

Home network 330 may include one or more STA 215-a in communication with an AP 205-a via a communication link 220-a. In some cases, UE 115-a may move from source network 305-a to home network 330 of AP 205-a. UE 115-a may communicate with AP 205-a via a communication link 220-b. UE 115-a may communicate with STA 215-a directly (e.g., peer-to-peer) using direct wireless link 225-a, or indirectly via AP 205-a using communication link 220-a and communication link 220-b. The source network 305-a may be associated with a different radio access technology (RAT) than the home network 330 as shown, or the source network 305-a may be associated with the same RAT as the home network 330.

In some cases, a UE 115-a may identify content (e.g., music, movies, etc., stored in a data file) of a source network 305-a, including from the internet or third-party content providers or servers accessible by UE 115-a using communication resources of source network 305-a. Before or after downloading a first portion of the content, the download may be interrupted. The interruption may be based on a user-initiated command (e.g., based on a user input to a download management application) or triggered automatically (e.g., based on the detection by the UE 115-a of an interruption condition at the UE 115-a). UE 115-a may identify a condition that has or will shortly interrupt a data download. For example, UE 115-a may detect a low battery condition and determine that it will soon turn off or enter a sleep state. A user may run out of available data, or UE 115-a may determine that the user will run out of available data, in the user's data plan or package before the download can complete. UE 115-a may have begun the download when a higher-speed connection was available, but UE 115-a has since moved to an area in which a lower-speed connection is available. In other examples, channel conditions may have changed for other reasons such as changing weather or movement of objects around UE 115-a or base station 105-a in coverage area 110-a. In some examples, UE 115-a may determine that it has low memory such that it is not desirable or not possible to complete the download. UE 115-a may also stop an active download where other services conflict with the current download. These situations may result in the download being halted or canceled, and a portion of the data downloaded by the UE 115-a lost, such that UE 115-a may need to later reinitiate the download, redownloading the same first portion of the data download that was previously downloaded by the UE, in addition to the remaining portion of the download. Restarting the download may waste the additional time, battery power, and data plan usage that were already expended downloading the first portion of the download. Thus, UE 115-a may determine to download the remaining portion of the data file at STA 215-a in home network 330. In some cases, the remaining portion of the data file may include the complete data file.

UE 115-a may transmit a download handover request to base station 105-a that identifies the data file to be downloaded by the target device. The base station 105-a may relay this request to the network node 320 via backhaul link 132-a. In some cases, the download handover request may be or be included in a connection release message (e.g., an RRCConnectionRelease message). The message may include an indication of the reason for the release request (e.g., DataHandover) and certain metadata associated with the data download associated with the download handover request, such as a number of bytes received for the associated data file, an internet protocol (IP) address associated with a server from which the data file was being downloaded, and a file name for the data file. The network node 320 may receive the message and determine that UE 115-a has requested to redirect the download of a second portion of the data file to another device (e.g., a target device such as a STA 215-a or AP 205-a in the home network 330).

Having received the download handover request, network node 320 may identify a target device (e.g., STA 215-a or AP 205-a) to use for downloading the second portion of the content. In some cases, a user may pre-register a list of potential target devices with the network node 320 and the user may associate a priority with each target device. As such, network node 320 may identify the target device based on the pre-registered list of potential target devices and the priorities of target devices included in the list. Network node 320 may attempt to establish a connection with the selected target device. In some examples, if the first attempt at connection is unsuccessful, network node 320 may select another target device according to the target device priority levels (e.g., starting with the highest priority, followed by the second highest priority, and so on). If no communication with a target device is successful, network node 320 may send a message to UE 115-a indicating that the download handover failed. Network node 320 may also send a message to UE 115-a indicating that download handover succeeded if a connection is successfully established. In some case, a confirmation message may be sent when the download handover occurs, or when the data download successfully completes at the target device, or both.

Network architecture 315 may communicate with home network 330 through internet 310 to page the target device and indicate that the reason for paging is to perform a download handover (e.g., forward or transfer a download). In some cases, source device (e.g., UE 115-a) and potential target devices (e.g., AP 205-a, STA 215-a) registration information may be stored in a database within network architecture 315. In some examples, the AP 205-a may page the target device, including metadata (e.g., some or all of the metadata included in the download handover request from source device, UE 115-a, or including additional metadata) to indicate the number of bytes received in the first portion of the download, if any, by indicating the server internet protocol (IP), and/or by indicating the file name of the download. The target device (e.g., STA 215-a) may then attempt to establish a connection to a server and download the second portion of the file. This attempt may include responding to the paging from network architecture 315 and communicating with AP 205-a to establish the connection to the server (e.g., via RRC signaling). If the target device is able to successfully resume the download of the second portion of the content, network node 320 may transmit a message to UE 115-a to indicate that the transfer of the download was successful. If the target device is not able to successfully resume the download of the second portion of the content, network node 320 may transmit a message to UE 115-a to indicate that the transfer of the download was unsuccessful.

In some examples, a user may be involved in the process of transferring the download to the target device. If the transfer is successful, network node 320 may inform the user accordingly and UE 115-a may halt the download of the remaining portion of the download. If the transfer is unsuccessful (e.g., where no target device is available), network node 320 may update the user accordingly and the user may be allowed to decide whether to continue the download on UE 115-a or abort the download. If the remaining portion is successfully downloaded at the target device (e.g., STA 215-a or AP 205-a), the remaining portion may be transmitted to UE 115-a, or the second portion may be transmitted to UE 115-a and combined with the first portion at UE 115-a, to complete the download. In some examples, the AP 205-a may store the remaining portion of the download and transmit the remaining portion to UE 115-a via communication link 220-b once UE 115-a is within home network 330 and has established a communication session with AP 205-a. In other examples, STA 215-a may store the remaining portion of the download and transmit the content to UE 115-a via direct wireless link 225-a once UE 115-a is within the home network 330 has established a peer-to-peer communication session with STA 215-a. In yet other examples, STA 215-a may complete the download and transmit the remaining portion of the download to UE 115-a via AP 205-a using communication link 220-a and communication link 220-b.

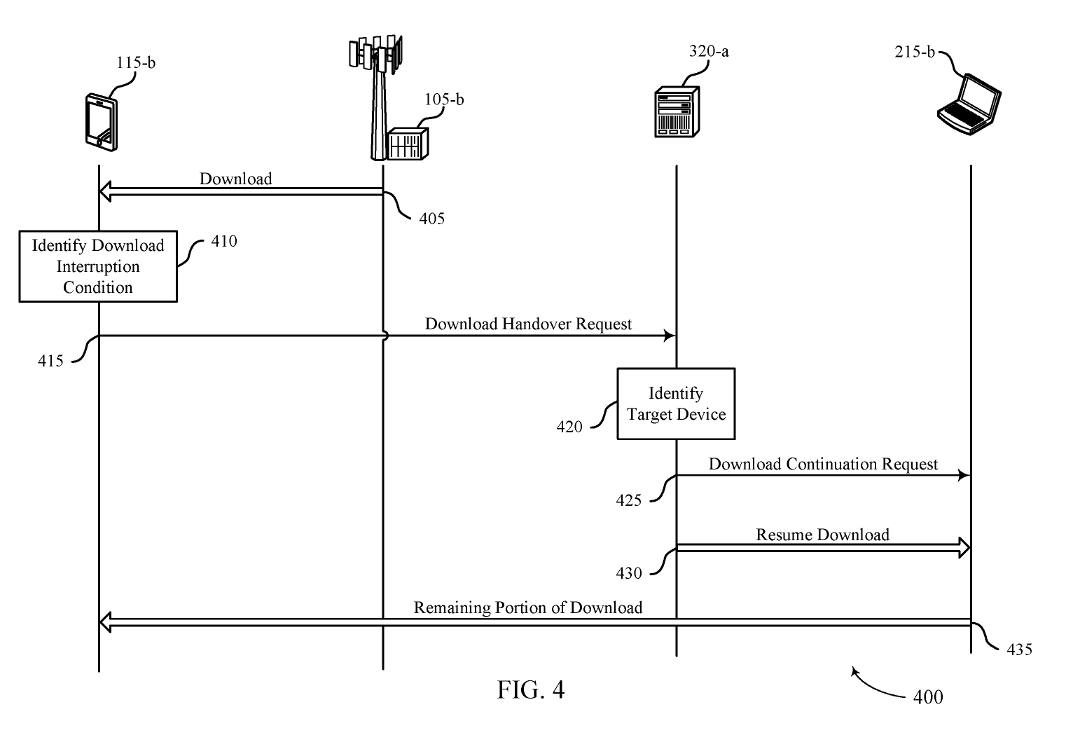

FIG. 4 illustrates an example of a process flow 400 for data download handover from device to device in accordance with various aspects of the present disclosure. Process flow 400 may include UE 115-b, base station 105-b, network node 320-a, and STA 215-b which may exemplify aspects of the corresponding devices as described with references to FIGS. 1-3.

At step 405, UE 115-b may identify a data file and, for example, initiate a download and receive content (e.g., music, movies, etc.) from a base station 105-b. UE 115-b may receive a first portion of a data file for a data download to the UE 115-b. Base station 105-b may be associated with a serving wireless network (e.g., a WWAN).

At block 410, UE 115-b may identify a download interruption condition that results in a download being aborted. The condition interrupting the data download at UE 115-b may include receiving a user command for UE 115-b to perform a download handover, determining that an amount of data used by the mobile device has exceeded a predetermined data usage threshold, determining that an amount of available storage of the mobile device has fallen below a predetermined storage threshold, determining that a transmission capacity for the mobile device has fallen below a predetermined capacity threshold, determining that a shutdown procedure for the mobile device has been initiated, determining that a battery level of the mobile device is less than a predetermined battery level threshold, or a combination of these conditions.

At step 415, UE 115-b may transmit a download handover request that requests a continuation of a data download for a remaining portion of a data file at a target device in a home network. In some cases, the home network may be an example of a WLAN, and the target device a UE, STA, AP, or other wireless device in communication with an AP of the WLAN. UE 115-b may determine to download the remaining portion of the data file at the target device based on identifying the download interruption condition. The download handover request may identify the data file. In some cases, UE 115-b may transmit the download handover request in an RRC message, for example an RRC connection release message including a release cause field or indicator indicating data handover as the release cause.

At block 420, network node 320-a may identify a target device to download the remaining portion of the content. Network node 320-a may identify the target device based on the identity of UE 115-b indicated by the download handover request. In some cases, network node 320-a may read a database of multiple target devices associated with UE 115-b to identify the target device. Additionally or alternatively, network node 320-a may receive a registration request from UE 115-b that identifies multiple target devices configured to receive download handovers from UE 115-b, and network node 320-a may associate the target devices with UE 115-b.

At step 425, the network node 320-a may transmit a download continuation request to the target device in the home network, for example STA 215-b, based on the received download handover request. The download continuation request may request that the target device in the home network continue a download of a data file, for example a second portion of the data file that has been partially downloaded at UE 115-b. The download continuation request may include information identifying the partially downloaded file. In some cases, the download continuation request may include a download handover paging message. The download handover paging message may include metadata associated with the remaining data file.

At step 430, network node 320-a may resume a download with STA 215-b and transmit the remaining portion of the download to STA 215-b, which may be the complete download a first portion of the download had not yet occurred at UE 115-b prior to identifying the download interruption condition at 410. STA 215-a may download the remaining portion of the data file based on the information identifying the partially downloaded data file received in the download continuation request at step 425.

At step 435, STA 215-b may transmit the remaining portion of the download to UE 115-b after completing the download. Before the transmission, STA 215-b may establish a communication session with UE 115-b in the home network. In some cases, STA 215-b may establish a wireless peer-to-peer file transfer session with UE 115-b in the home network.

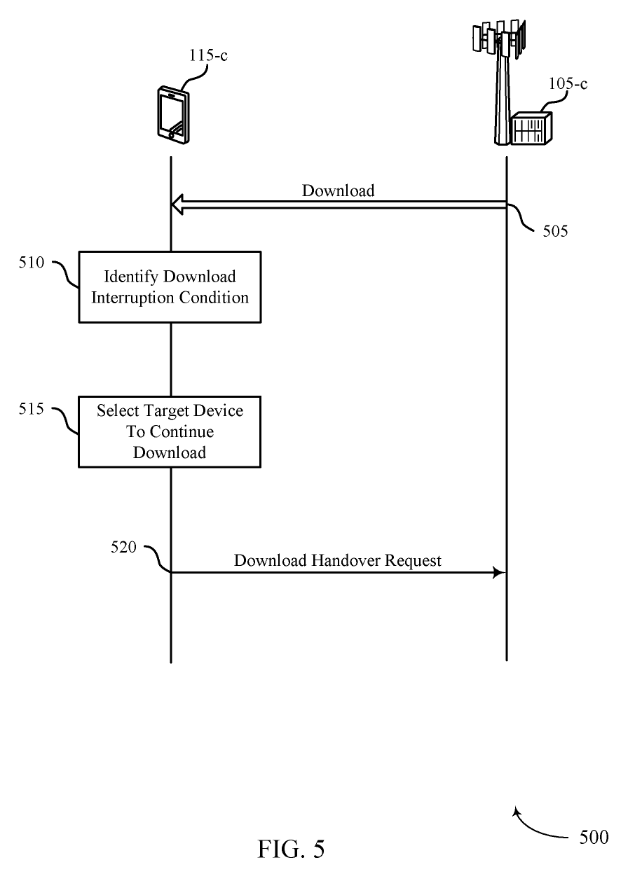

FIG. 5 illustrates an example of a process flow 500 for data download handover from device to device in accordance with various aspects of the present disclosure. Process flow 500 may include UE 115-c and base station 105-c which may exemplify aspects of corresponding devices as described with references to FIGS. 1-3.

At step 505, UE 115-c may identify a data file and, for example, initiate a download and receive content (e.g., music, movies, etc.) from a base station 105-b. UE 115-c may receive a first portion of a data file for a data download to the UE 115-c.

At block 510, UE 115-c may identify a download interruption condition that results in a download being aborted. The condition interrupting the data download at UE 115-c may include receiving a user command for UE 115-c to perform a download handover, determining that an amount of data used by the mobile device has exceeded a predetermined data usage threshold, determining that an amount of available storage of the mobile device has fallen below a predetermined storage threshold, determining that a transmission capacity for the mobile device has fallen below a predetermined capacity threshold, determining that a shutdown procedure for the mobile device has been initiated, determining that a battery level of the mobile device is below a predetermined battery level threshold, or a combination of these conditions.

At block 515, UE 115-c may select a target device to download of the remaining portion of the content. In some cases, the target device may be selected from a set of target devices (e.g., based on user input or based on an assigned priority of the target devices within the set).

At step 520, UE 115-c may transmit a download handover request to base station 105-b requesting that the remaining portion of the download be redirected to the selected target device. In some cases, the download handover request may be transmitted in a RRC message.

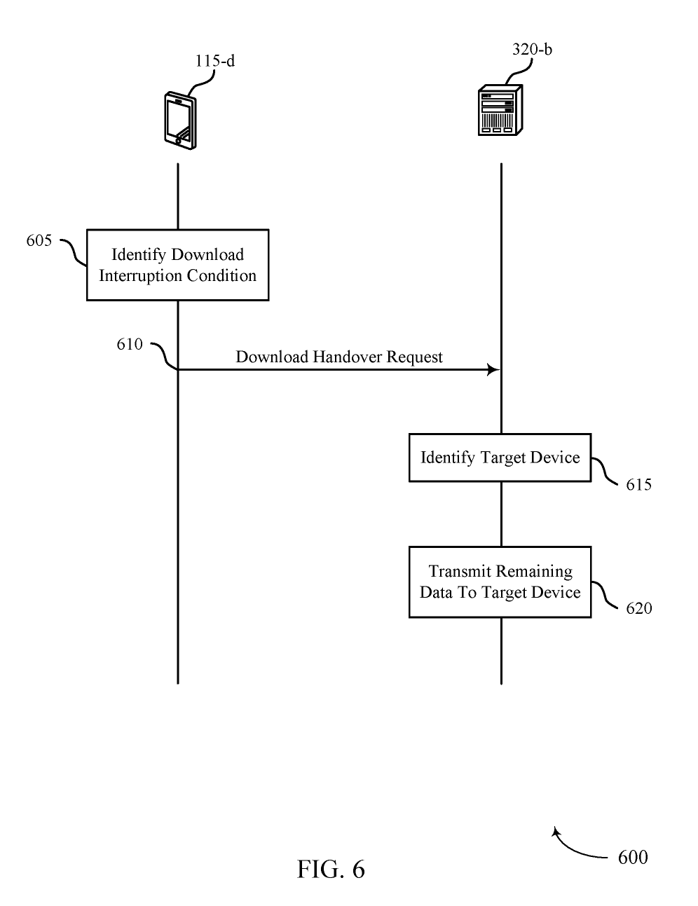

FIG. 6 illustrates an example of a process flow 600 for data download handover from device to device in accordance with various aspects of the present disclosure. Process flow 600 may include UE 115-d and network node 320-b which may exemplify aspects of corresponding devices as described with references to FIGS. 1-3.

At block 605, UE 115-d may identify a download interruption condition that results in a download being aborted. The condition interrupting the data download at UE 115-b may include receiving a user command for UE 115-b to perform a download handover, determining that an amount of data used by the mobile device has exceeded a predetermined data usage threshold, determining that an amount of available storage of the mobile device has fallen below a predetermined storage threshold, determining that a transmission capacity for the mobile device has fallen below a predetermined capacity threshold, determining that a shutdown procedure for the mobile device has been initiated, determining that a battery level of the mobile device is less than a predetermined battery level threshold, or a combination of these conditions.

At step 610, UE 115-d may transmit a download handover request to network node 320-b requesting that the remaining portion of the download be redirected to a target device. The download handover request may be transmitted, for example, in a RRC message. In some cases, the download handover request may first pass through a base station 105 before being forwarded to the network node 320-b. The download handover request may include metadata associated with the data file.

At block 615, the network node 320-b may identify a target device to download the remaining portion of the content. In some cases, the target device may be identified from reading a data base that includes target device registration information. The data base may be part of the network node 320-b, or may be a separate entity within the network. In other cases, the target device may be identified based on a registration request from UE 115-d that identifies a particular target device.

At block 620, the network node 320-b may transmit the remaining portion of the download to the target device.

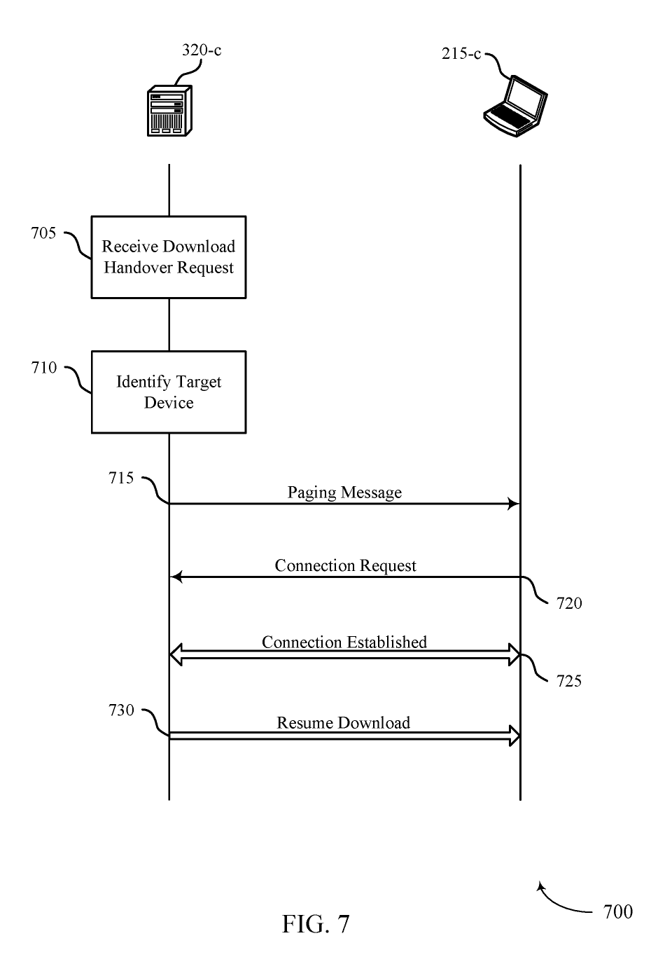

FIG. 7 illustrates an example of a process flow 700 for data download handover from device to device in accordance with various aspects of the present disclosure. Process flow 700 may include network node 320-c, and STA 215-c which may exemplify aspects of corresponding devices as described with references to FIGS. 1-3. In the present example, STA 215-c may represent a target device for a download handover and may be used interchangeably with a STA 215.

At block 705, network node 320-c may receive a download handover request that requests a remaining portion of a download be redirected to a target device. In some cases, the download handover request may be received from a UE 115. At block 710, network node 320-c may identify the target device to download the remaining portion of the content. At step 715, network node 320-c may page STA 215-c to indicate that a device has requested download handover to a target device in a home network associated with STA 215-c. In some cases, the paging may include a download continuation request. The download continuation request may request that the target device continue the download of the data file that has been partially-downloaded at another device (e.g., at a UE 115). That is, the download continuation request may include information identifying the remaining data file. In some examples, the download continuation request comprises a download handover paging message which may include metadata associated with the data file.

At step 720, STA 215-c may transmit a connection request that requests a connection with network node 320-c to receive the remaining portion of the content. At step 725, network node 320-c may establish the connection with STA 215-c to facilitate the download of the remaining portion of the content. In some cases, establishing the connection with STA 215-c may include establishing a wireless peer-to-peer file transfer session between the mobile device and the target device (e.g., STA 215-c).

At step 730, STA 215-c may resume the download and receive the remaining portion of the content from network node 320-c. In some cases, the remaining portion of the data file may be downloaded based on the information identifying the remaining data file received in step 715.

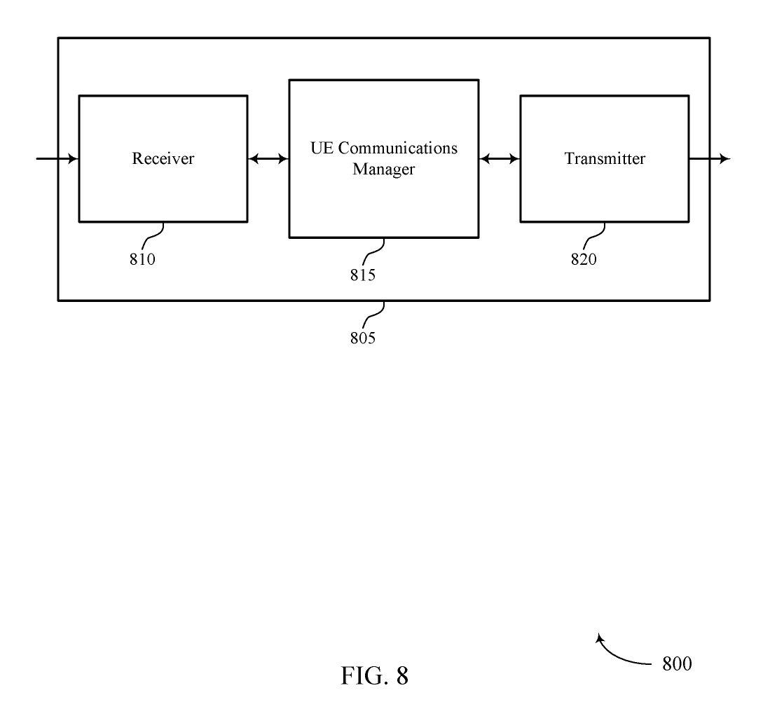

FIG. 8 shows a block diagram 800 of a wireless device 805 that supports data download handover from device to device in accordance with various aspects of the present disclosure. Wireless device 805 may be an example of aspects of a UE 115 as described with reference to FIG. 1. Wireless device 805 may include receiver 810, UE communications manager 815, and transmitter 820. Wireless device 805 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses). Wireless device 805 may also include one or more processors, memory coupled with the one or more processors, and instructions stored in the memory that are executable by the one or more processors to enable the one or more processors to perform the data download handover features discussed herein. Each of these components may be in communication with each other.

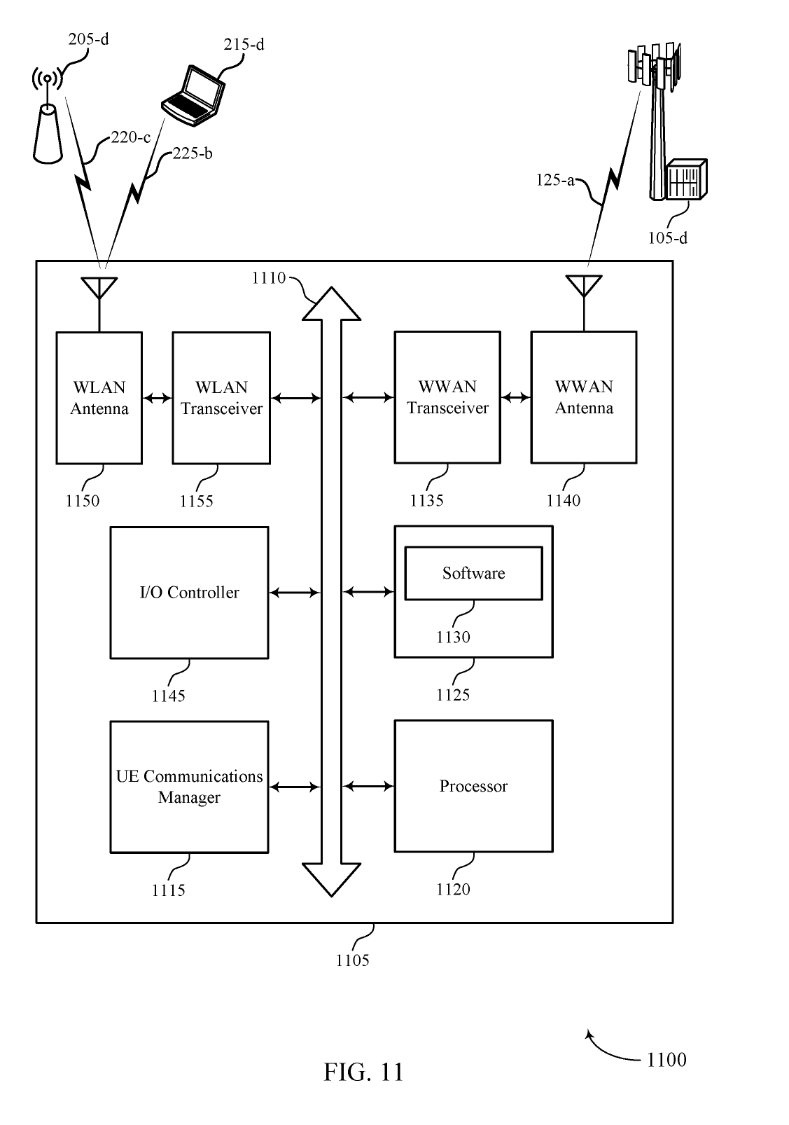

Receiver 810 may receive information such as packets, user data, or control information associated with various information channels (e.g., control channels, data channels, and information related to data download handover from device to device, etc.). Information may be passed on to other components of the device. The receiver 810 may be an example of aspects of the WWAN transceiver 1135 or WLAN transceiver 1155 described with reference to FIG. 11.

UE communications manager 815 may be an example of aspects of the UE communications manager 1115 described with reference to FIG. 11. UE communications manager 815 may identify, at the mobile device in a serving wireless network, a data file for a data download, identify a condition interrupting the data download at the mobile device, determine to download a remaining portion of the data file at a target device of a home network based on identifying the condition, and transmit, to the serving wireless network, a download handover request that identifies the data file to be downloaded by the target device.

Transmitter 820 may transmit signals generated by other components of the device. In some examples, the transmitter 820 may be collocated with a receiver 810 in a transceiver module. For example, the transmitter 820 may be an example of aspects of the WWAN transceiver 1135 or WLAN transceiver 1155 described with reference to FIG. 11. The transmitter 820 may include a single antenna, or it may include a set of antennas.

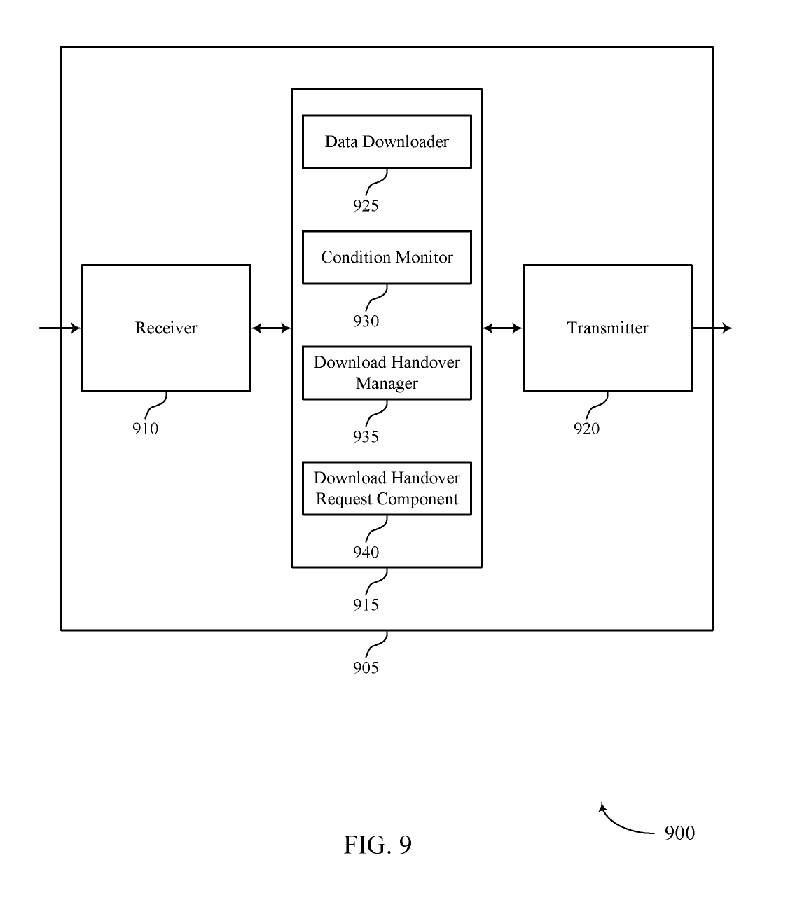

FIG. 9 shows a block diagram 900 of a wireless device 905 that supports data download handover from device to device in accordance with various aspects of the present disclosure. Wireless device 905 may be an example of aspects of a wireless device 805 or a UE 115 as described with reference to FIGS. 1 and 8. Wireless device 905 may include receiver 910, UE communications manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to data download handover from device to device, etc.). Information may be passed on to other components of the device. The receiver 910 may be an example of aspects of the WWAN transceiver 1135 or WLAN transceiver 1155 described with reference to FIG. 11.

UE communications manager 915 may be an example of aspects of the UE communications manager 1115 described with reference to FIG. 11. UE communications manager 915 may also include data downloader 925, condition monitor 930, download handover manager 935, and download handover request component 940.

Data downloader 925 may identify, at the mobile device in a serving wireless network, a data file for a data download. In some cases, the serving wireless network includes a WWAN.

Condition monitor 930 may identify a condition interrupting the data download at the mobile device. The condition may include determining that an amount of data used by the mobile device has exceeded a predetermined data usage threshold, determining that an amount of available storage of the mobile device has fallen below a predetermined storage threshold, determining that a transmission capacity for the mobile device has fallen below a predetermined capacity threshold, determining that a shutdown procedure for the mobile device has been initiated, determining that a battery level of the mobile device is below a predetermined battery level threshold, or a combination thereof. In some cases, identifying the condition interrupting the data download includes: receiving a user command for the mobile device to perform a download handover.

Download handover manager 935 may determine to download a remaining portion of the data file at a target device of a home network based on identifying the condition. In some cases, the remaining portion of the data file may include the complete data file. Further, the home network may include a WLAN or a WWAN.

Download handover request component 940 may transmit, to the serving wireless network, a download handover request that identifies the data file to be downloaded by the target device and transmit the download handover request in a RRC message to the serving wireless network.

Transmitter 920 may transmit signals generated by other components of the device. In some examples, the transmitter 920 may be collocated with a receiver 910 in a transceiver module. For example, the transmitter 920 may be an example of aspects of the WWAN transceiver 1135 or WLAN transceiver 1155 described with reference to FIG. 11. The transmitter 920 may include a single antenna, or it may include a set of antennas.

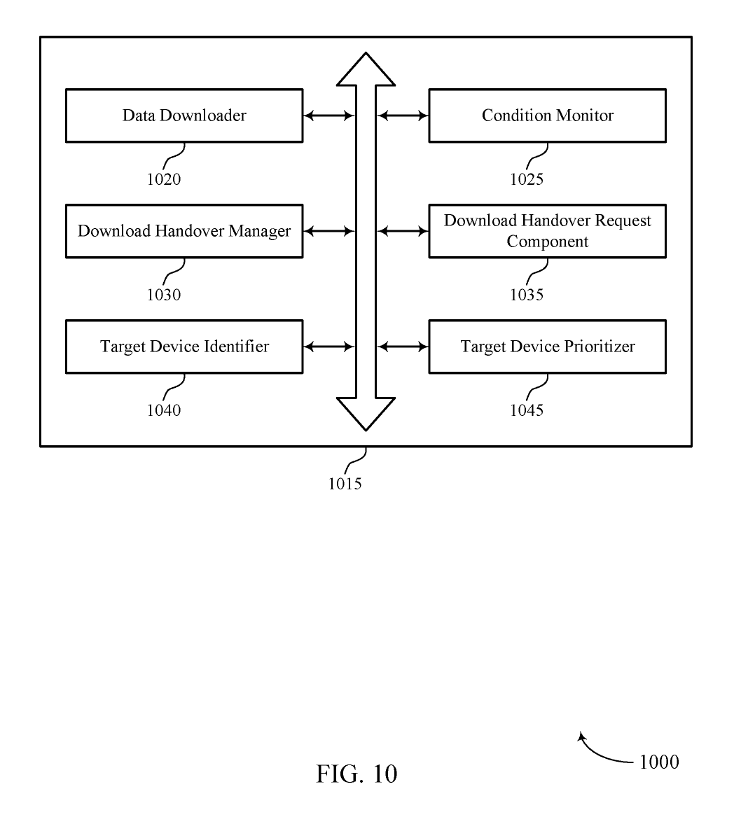

FIG. 10 shows a block diagram 1000 of a UE communications manager 1015 that supports data download handover from device to device in accordance with various aspects of the present disclosure. The UE communications manager 1015 may be an example of aspects of a UE communications manager 815, a UE communications manager 915, or a UE communications manager 1115 described with reference to FIGS. 8, 9, and 11. The UE communications manager 1015 may include data downloader 1020, condition monitor 1025, download handover manager 1030, download handover request component 1035, target device identifier 1040, and target device prioritizer 1045. Each of these modules may communicate, directly or indirectly, with one another (e.g., via one or more buses).

Data downloader 1020 may identify, at the mobile device in a serving wireless network, a data file for a data download. In some cases, the serving wireless network includes a WWAN.

Condition monitor 1025 may identify a condition interrupting the data download at the mobile device. The condition may include determining that an amount of data used by the mobile device has exceeded a predetermined data usage threshold, determining that an amount of available storage of the mobile device has fallen below a predetermined storage threshold, determining that a transmission capacity for the mobile device has fallen below a predetermined capacity threshold, determining that a shutdown procedure for the mobile device has been initiated, determining that a battery level of the mobile device is below a predetermined battery level threshold, or a combination thereof. In some cases, identifying the condition interrupting the data download includes: receiving a user command for the mobile device to perform a download handover.

Download handover manager 1030 may determine to download a remaining portion of the data file at a target device of a home network based on identifying the condition. In some cases, the remaining portion of the data file may include the complete data file. Further, the home network may include a WLAN.

Download handover request component 1035 may transmit, to the serving wireless network, a download handover request that identifies the data file to be downloaded by the target device and transmit the download handover request in a RRC message to the serving wireless network.

Target device identifier 1040 may select the target device to download the remaining portion of the data file from among a set of target devices, identify one or more target devices to receive download handovers in the home network for the mobile device, where the one or more target devices include the target device, and transmit, to the serving wireless network, a registration request for the serving wireless network to associate the mobile device with the one or more target devices.

Target device prioritizer 1045 may assign a priority to each of the respective one or more target devices, where the registration request further includes the assigned priorities.

FIG. 11 shows a diagram of a system 1100 including a device 1105 that supports data download handover from device to device in accordance with various aspects of the present disclosure. Device 1105 may be an example of or include the components of wireless device 805, wireless device 905, or a UE 115 as described above, e.g., with reference to FIGS. 1, 8 and 9. Device 1105 may include components for bi-directional voice and data communications including components for transmitting and receiving communications, including UE communications manager 1115, processor 1120, memory 1125, software 1130, WWAN transceiver 1135 and WLAN transceiver 1155, WWAN antenna 1140 and WLAN antenna 1150, and I/O controller 1145. These components may be in electronic communication via one or more busses (e.g., bus 1110). Device 1105 may communicate wirelessly with one or more base stations 105, APs 205, and/or STAs 215. In some examples, device 1105 may represent aspects of a UE 115 as described herein.

Processor 1120 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting data download handover from device to device).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support data download handover from device to device. Software 1130 may be stored in a non-transitory computer-readable medium such as system memory or other memory. In some cases, the software 1130 may not be directly executable by the processor but may cause a computer (e.g., when compiled and executed) to perform functions described herein.

WWAN transceiver 1135 and WLAN transceiver 1155 may communicate bi-directionally, via one or more antennas, wired, or wireless links as described above. For example, the WWAN transceiver 1135 and WLAN transceiver 1155 may represent a wireless transceiver and may communicate bi-directionally with another wireless transceiver. The WWAN transceiver 1135 and WLAN transceiver 1155 may also include a modem to modulate the packets and provide the modulated packets to the antennas for transmission, and to demodulate packets received from their respective antennas.

In some cases, the wireless device may include a single antenna. However, in some cases the device may have more than one antenna (e.g., WWAN antenna 1140 and WLAN antenna 1150), which may be capable of concurrently transmitting or receiving multiple wireless transmissions. For example, device 1105 may utilize WWAN transceiver 1135 and WWAN antenna 1140 for WWAN communications (e.g., to communicate with base station 105-d over a communication link 125-a). Device 1105 may further utilize WLAN transceiver 1155 and WLAN antenna 1150 for WLAN communications (e.g., to communicate with AP 205-d over communication link 220-c or to communicate with STA 215-d over a direct wireless link 225-b).

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system.

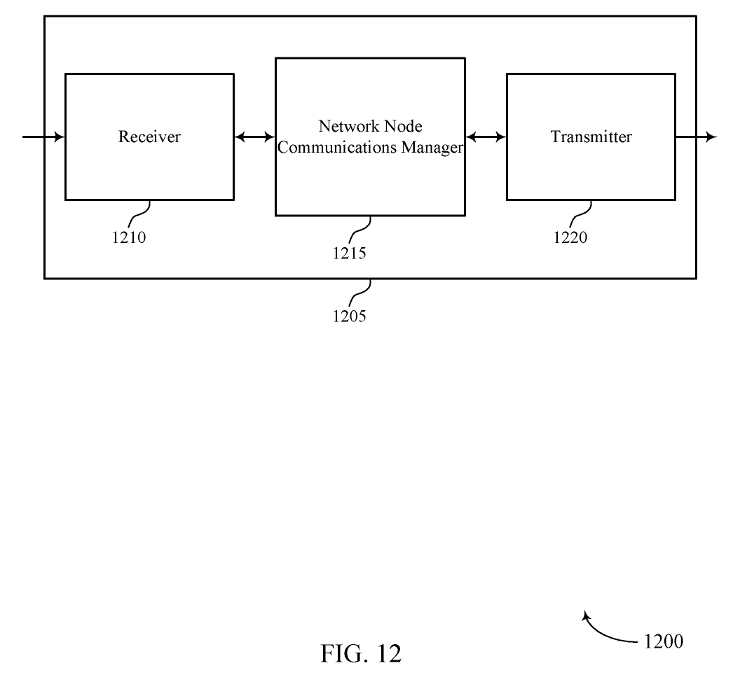

FIG. 12 shows a block diagram 1200 of a wireless device 1205 that supports data download handover from device to device in accordance with various aspects of the present disclosure. Wireless device 1205 may be an example of aspects of a network node 320 as described with reference to FIG. 3. Wireless device 1205 may include receiver 1210, network node communications manager 1215, and transmitter 1220. Wireless device 1205 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

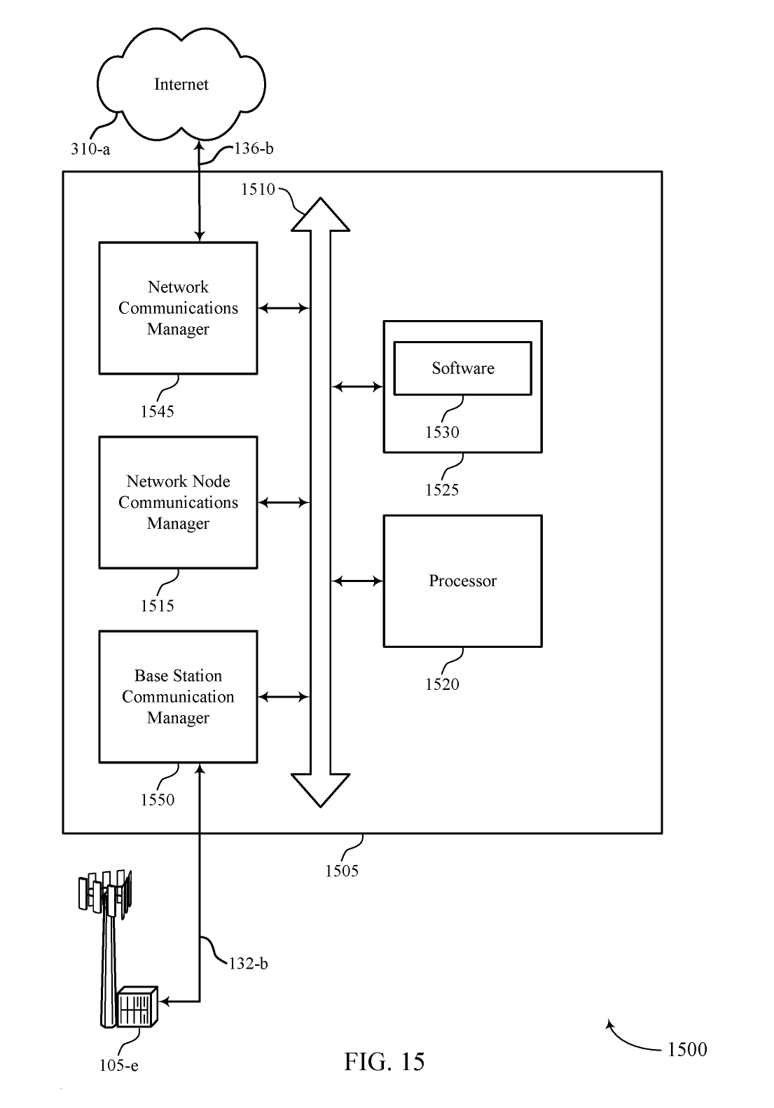

Receiver 1210 may receive information such as packets, user data, or control information associated with various information channels (e.g., control channels, data channels, and information related to data download handover from device to device, etc.). Information may be passed on to other components of the device. The receiver 1210 may be an example of aspects of the transceiver 1535 described with reference to FIG. 15.

Network node communications manager 1215 may be an example of aspects of the network node communications manager 1515 described with reference to FIG. 15. Network node communications manager 1215 may receive, at the network node, a download handover request from a mobile device that identifies a data file and requests a data download for a remaining portion of the data file at a target device in a home network, identify the target device based on an identity of the mobile device, and transmit a download continuation request that requests that the target device download the remaining portion of the data file to the target device.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1535 described with reference to FIG. 15. The transmitter 1220 may include a single antenna, or it may include a set of antennas.

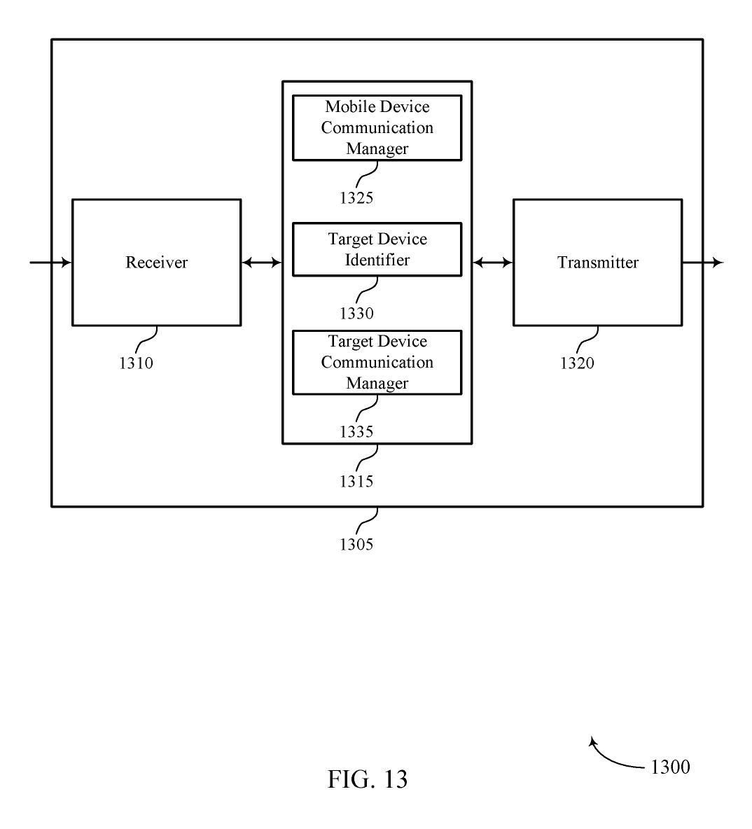

FIG. 13 shows a block diagram 1300 of a wireless device 1305 that supports data download handover from device to device in accordance with various aspects of the present disclosure. Wireless device 1305 may be an example of aspects of a wireless device 1205 or a network node 320 as described with reference to FIGS. 3 and 12. Wireless device 1305 may include receiver 1310, network node communications manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to data download handover from device to device, etc.). Information may be passed on to other components of the device. The receiver 1310 may be an example of aspects of the transceiver 1535 described with reference to FIG. 15.

Network node communications manager 1315 may be an example of aspects of the network node communications manager 1515 described with reference to FIG. 15. Network node communications manager 1315 may also include mobile device communication manager 1325, target device identifier 1330, and target device communication manager 1335.

Mobile device communication manager 1325 may receive, at the network node, a download handover request from a mobile device that identifies a data file and requests a data download for a remaining portion of the data file at a target device in a home network. In some cases, receiving the download handover request from the mobile device includes receiving the download handover request from a base station serving the mobile device in a communications network that includes the base station and the network node. In some cases, the download handover request includes metadata associated with the data file.

Target device identifier 1330 may identify the target device based on an identity of the mobile device. In some cases, identifying the target device includes: reading a database including identifying information for one or more target devices that are associated with one or more mobile devices, where the one or more mobile devices include the mobile device, and where the one or more target devices include the target device.

Target device communication manager 1335 may transmit a download continuation request that requests that the target device download the remaining portion of the data file to the target device, receive, from the target device and in response to the download continuation request, a request to transmit the remaining portion of the data file, and transmit the remaining portion of the data file to the target device.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1535 described with reference to FIG. 15. The transmitter 1320 may include a single antenna, or it may include a set of antennas.

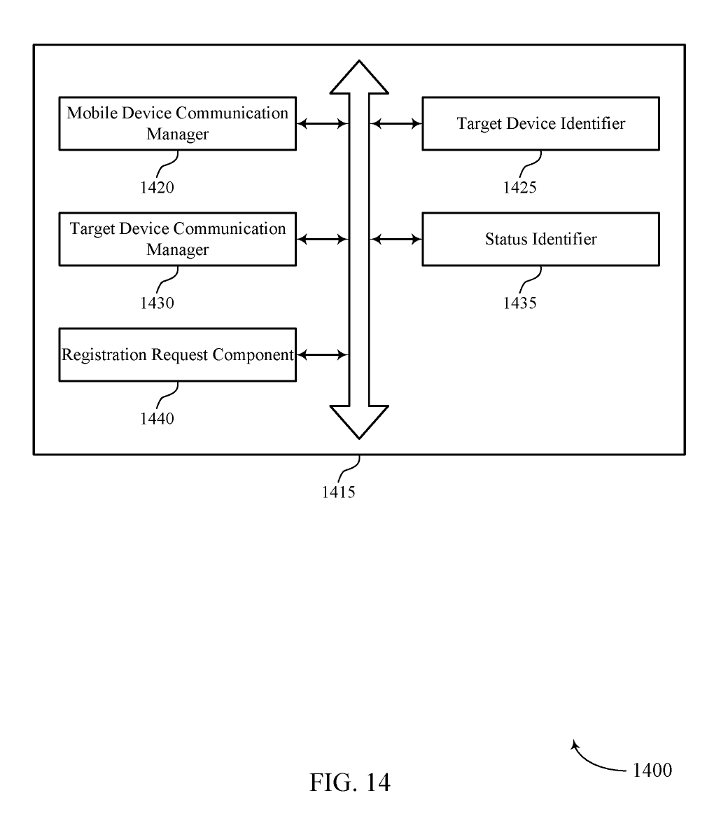

FIG. 14 shows a block diagram 1400 of a network node communications manager 1415 that supports data download handover from device to device in accordance with various aspects of the present disclosure. The network node communications manager 1415 may be an example of aspects of a network node communications manager 1515 described with reference to FIGS. 12, 13, and 15. The network node communications manager 1415 may include mobile device communication manager 1420, target device identifier 1425, target device communication manager 1430, status identifier 1435, and registration request component 1440. Each of these modules may communicate, directly or indirectly, with one another (e.g., via one or more buses).

Mobile device communication manager 1420 may receive, at the network node, a download handover request from a mobile device that identifies a data file and requests a data download for a remaining portion of the data file at a target device in a home network. In some cases, receiving the download handover request from the mobile device includes: receiving the download handover request from a base station serving the mobile device in a communications network that includes the base station and the network node. In some cases, the download handover request includes metadata associated with the data file.

Target device identifier 1425 may identify the target device based on an identity of the mobile device. In some cases, identifying the target device includes: reading a database including identifying information for one or more target devices that are associated with one or more mobile devices, where the one or more mobile devices include the mobile device, and where the one or more target devices include the target device.

Target device communication manager 1430 may transmit a download continuation request that requests that the target device download the remaining portion of the data file to the target device, receive, from the target device and in response to the download continuation request, a request to transmit the remaining portion of the data file, and transmit the remaining portion of the data file to the target device.

Status identifier 1435 may determine a status of the data download and transmit a status update message to the mobile device based on the determined status.

Registration request component 1440 may receive, from the mobile device, a registration request identifying one or more target devices configured to receive download handovers from the mobile device, where the one or more target devices include the target device, associate the one or more target devices with the mobile device, and associate a priority value with each of the respective one or more target devices.

FIG. 15 shows a diagram of a system 1500 including a device 1505 that supports data download handover from device to device in accordance with various aspects of the present disclosure. Device 1505 may be an example of or include the components of network node 320 as described above, e.g., with reference to FIG. 3. Device 1505 may include components for bi-directional voice and data communications including components for transmitting and receiving communications, including network node communications manager 1515, processor 1520, memory 1525, software 1530, network communications manager 1545, and base station communications manager 1550. These components may be in electronic communication via one or more busses (e.g., bus 1510). Device 1505 may communicate wirelessly with one or more base stations 105, APs 205, and/or the internet 310. In some examples, device 1505 may represent aspects of a network node 320 as described herein.

Network node communications manager 1515 may manage communications with other base station 105-e, and may include a controller or scheduler for controlling communications with UEs 115 in cooperation with other base stations 105-e. For example, the network node communications manager 1515 may coordinate scheduling for transmissions to UEs 115 for various interference mitigation techniques such as beamforming or joint transmission. In some examples, network node communications manager 1515 may provide an X2 interface within an Long Term Evolution (LTE)/LTE-A wireless communication network technology to provide communication between base stations 105.

Processor 1520 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting data download handover from device to device).

Memory 1525 may include RAM and ROM. The memory 1525 may store computer-readable, computer-executable software 1530 including instructions that, when executed, cause the processor to perform various functions described herein. In some cases, the memory 1525 may contain, among other things, a BIOS which may control basic hardware and/or software operation such as the interaction with peripheral components or devices.

Software 1530 may include code to implement aspects of the present disclosure, including code to support data download handover from device to device. Software 1530 may be stored in a non-transitory computer-readable medium such as system memory or other memory. In some cases, the software 1530 may not be directly executable by the processor but may cause a computer (e.g., when compiled and executed) to perform functions described herein.

Network communications manager 1545 may manage communications with the core network (e.g., via one or more wired backhaul links). In some cases, the network communications manager 1545 may manage the transfer of data communications for client devices, such as one or more UEs 115. For example, network communications manager may communicate with the internet 310-a via internet link 136-b.

Base station communications manager 1550 may manage communications with other base stations 105-e (e.g., via backhaul link 132-b), and may include a controller or scheduler for controlling communications with UEs 115 in cooperation with other base stations 105-e. For example, the base station communications manager 1550 may coordinate scheduling for transmissions to UEs 115 for various interference mitigation techniques such as beamforming or joint transmission. In some examples, base station communications manager 1550 may provide an X2 interface within an LTE/LTE-A wireless communication network technology to provide communication between base stations 105.

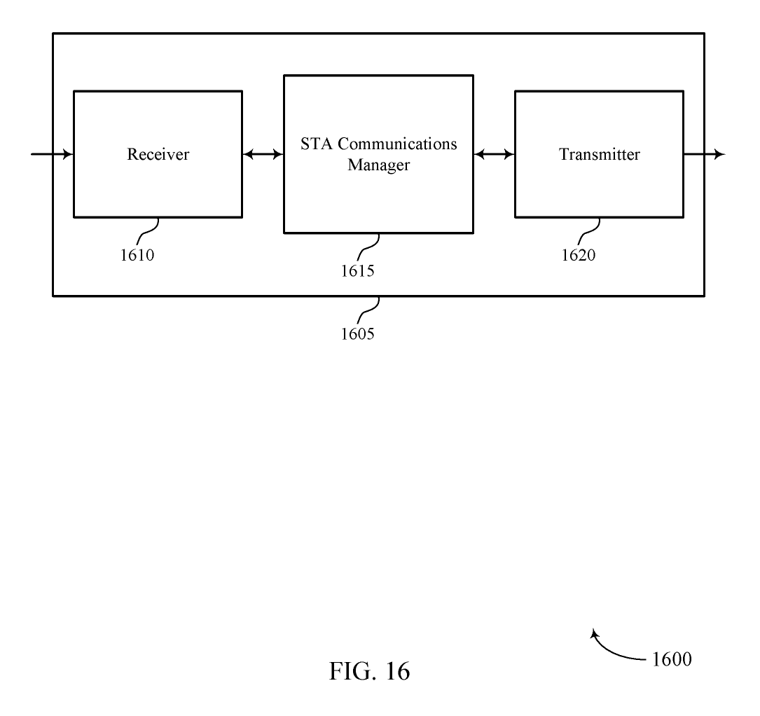

FIG. 16 shows a block diagram 1600 of a wireless device 1605 that supports data download handover from device to device in accordance with various aspects of the present disclosure. Wireless device 1605 may be an example of aspects of a station (STA) 115 as described with reference to FIG. 1. Wireless device 1605 may include receiver 1610, STA communications manager 1615, and transmitter 1620. Wireless device 1605 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

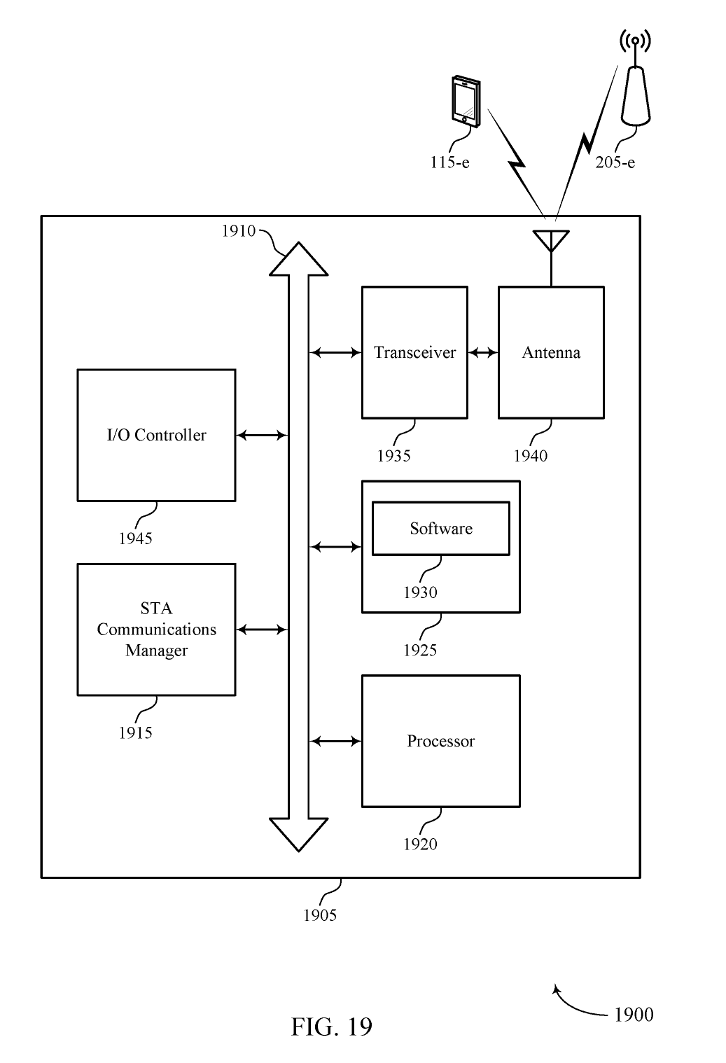

Receiver 1610 may receive information such as packets, user data, or control information associated with various information channels (e.g., control channels, data channels, and information related to data download handover from device to device, etc.). Information may be passed on to other components of the device. The receiver 1610 may be an example of aspects of the transceiver 1935 described with reference to FIG. 19.

STA communications manager 1615 may be an example of aspects of the STA communications manager 1915 described with reference to FIG. 19. STA communications manager 1615 may receive, from a network node of a communications network, a download continuation request that requests that the target device in a home network download a remaining portion of a data file for a mobile device, wherein the download continuation request comprises information identifying the data file, download, to the target device, the remaining portion of the data file based on the information identifying the data file, establish a communication session with the mobile device in the home network, and transmit the remaining portion of the data file to the mobile device.

Transmitter 1620 may transmit signals generated by other components of the device. In some examples, the transmitter 1620 may be collocated with a receiver 1610 in a transceiver module. For example, the transmitter 1620 may be an example of aspects of the transceiver 1935 described with reference to FIG. 19. The transmitter 1620 may include a single antenna, or it may include a set of antennas.

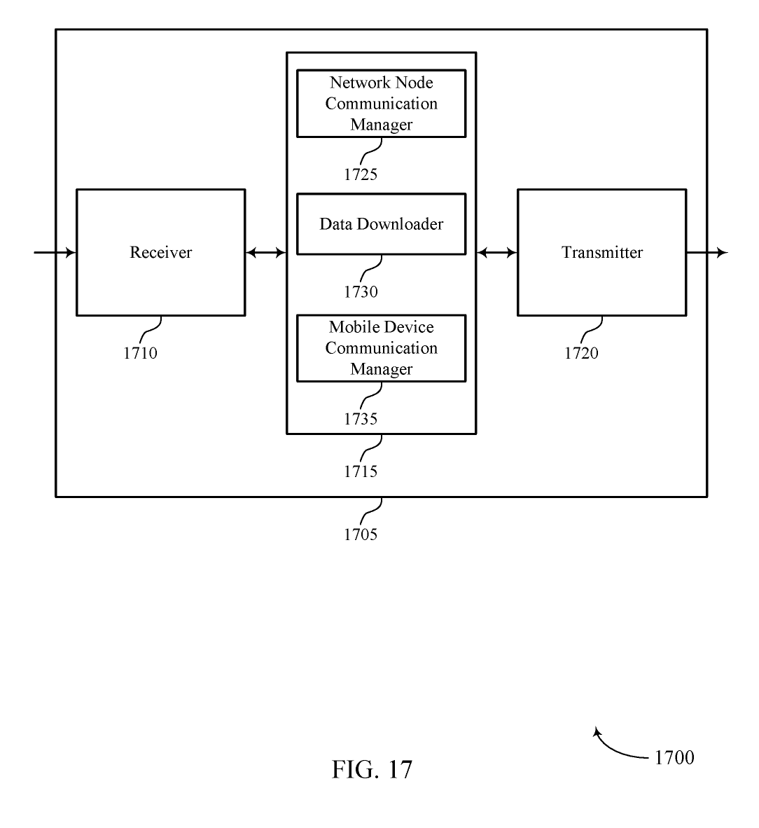

FIG. 17 shows a block diagram 1700 of a wireless device 1705 that supports data download handover from device to device in accordance with various aspects of the present disclosure. Wireless device 1705 may be an example of aspects of a wireless device 1605 or a UE 115 as described with reference to FIGS. 1 and 16. Wireless device 1705 may include receiver 1710, STA communications manager 1715, and transmitter 1720. Wireless device 1705 may also include a processor. Each of these components may be in communication with one another (e.g., via one or more buses).

Receiver 1710 may receive information such as packets, user data, or control information associated with various information channels (e.g., control channels, data channels, and information related to data download handover from device to device, etc.). Information may be passed on to other components of the device. The receiver 1710 may be an example of aspects of the transceiver 1935 described with reference to FIG. 19.

STA communications manager 1715 may be an example of aspects of the STA communications manager 1915 described with reference to FIG. 19. STA communications manager 1715 may also include network node communications manager 1725, data downloader 1730, and mobile device communication manager 1735.

Network node communications manager 1725 may receive, from a network node of a communications network, a download continuation request that requests that the target device in a home network download a remaining portion of a data file for a mobile device, wherein the download continuation request comprises information identifying the data file. In some cases, the download continuation request includes a download handover paging message.

Data downloader 1730 may download, to the target device, the remaining portion of the data file based on the information identifying the data file.

Mobile device communication manager 1735 may establish a communication session with the mobile device in the home network and transmit the remaining portion of the data file to the mobile device.

Transmitter 1720 may transmit signals generated by other components of the device. In some examples, the transmitter 1720 may be collocated with a receiver 1710 in a transceiver module. For example, the transmitter 1720 may be an example of aspects of the transceiver 1935 described with reference to FIG. 19. The transmitter 1720 may include a single antenna, or it may include a set of antennas.

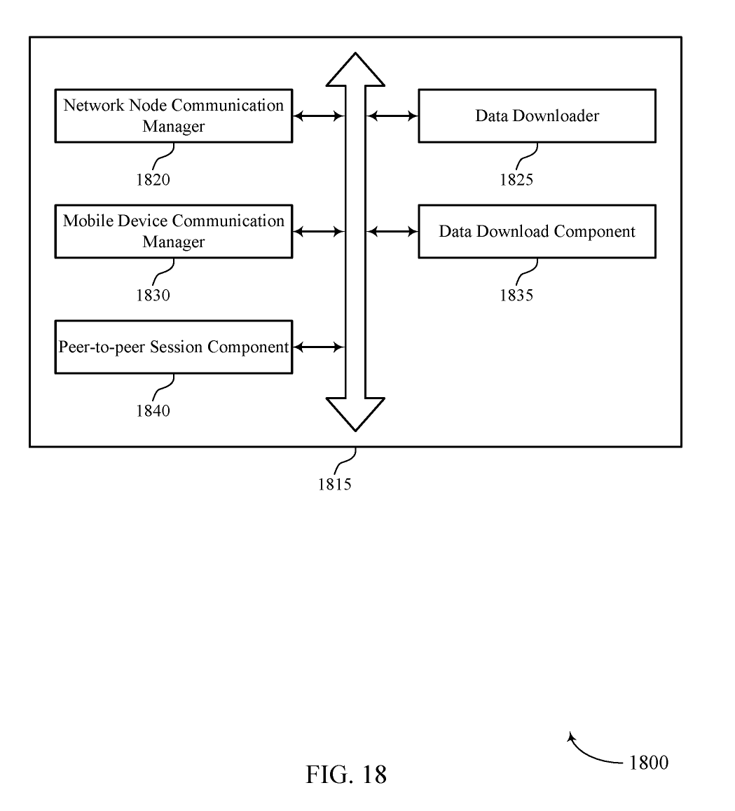

FIG. 18 shows a block diagram 1800 of a STA communications manager 1815 that supports data download handover from device to device in accordance with various aspects of the present disclosure. The STA communications manager 1815 may be an example of aspects of a STA communications manager 1915 described with reference to FIGS. 16, 17, and 19. The STA communications manager 1815 may include network node communications manager 1820, data downloader 1825, mobile device communication manager 1830, data download component 1835, and peer-to-peer session component 1840. Each of these modules may communicate, directly or indirectly, with one another (e.g., via one or more buses).

Network node communications manager 1820 may receive, from a network node of a communications network, a download continuation request that requests that the target device in a home network download a remaining portion of a data file for a mobile device, wherein the download continuation request comprises information identifying the data file. In some cases, the download continuation request includes a download handover paging message.

Data downloader 1825 may download, to the target device, the remaining portion of the data file based on the information identifying the data file.

Mobile device communication manager 1830 may establish a communication session with the mobile device in the home network and transmit the remaining portion of the data file to the mobile device. Peer-to-peer session component 1840 may manage and/or establish wireless peer-to-peer file transfer sessions. In some cases, establishing the communication session with the mobile device includes: establishing a wireless peer-to-peer file transfer session between the mobile device and the target device via the peer-to-peer session component 1840.

Data download component 1835 may transmit, to the network node, a request to transmit the remaining portion of the data file based on receiving the download continuation request and download the remaining portion of the data file from the network node. In some cases, the download handover paging message includes metadata associated with the data file.

FIG. 19 shows a diagram of a system 1900 including a device 1905 that supports data download handover from device to device in accordance with various aspects of the present disclosure. Device 1905 may be an example of or include the components of STA 215 or AP 205 as described above, e.g., with reference to FIG. 2. Device 1905 may include components for bi-directional voice and data communications including components for transmitting and receiving communications, including STA communications manager 1915, processor 1920, memory 1925, software 1930, transceiver 1935, antenna 1940, and I/O controller 1945. These components may be in electronic communication via one or more busses (e.g., bus 1910).

Processor 1920 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1920 may be configured to operate a memory array using a memory controller. In other cases, a memory controller may be integrated into processor 1920. Processor 1920 may be configured to execute computer-readable instructions stored in a memory to perform various functions (e.g., functions or tasks supporting data download handover from device to device).

Memory 1925 may include RAM and ROM. The memory 1925 may store computer-readable, computer-executable software 1930 including instructions that, when executed, cause the processor to perform various functions described herein. In some cases, the memory 1925 may contain, among other things, a BIOS which may control basic hardware and/or software operation such as the interaction with peripheral components or devices.

Software 1930 may include code to implement aspects of the present disclosure, including code to support data download handover from device to device. Software 1930 may be stored in a non-transitory computer-readable medium such as system memory or other memory. In some cases, the software 1930 may not be directly executable by the processor but may cause a computer (e.g., when compiled and executed) to perform functions described herein.

Transceiver 1935 may communicate bi-directionally, via one or more antennas, wired, or wireless links as described above. For example, the transceiver 1935 may represent a wireless transceiver and may communicate bi-directionally with another wireless transceiver. The transceiver 1935 may also include a modem to modulate the packets and provide the modulated packets to the antennas for transmission, and to demodulate packets received from the antennas.

In some cases, the wireless device may include a single antenna 1940. However, in some cases the device may have more than one antenna 1940, which may be capable of concurrently transmitting or receiving multiple wireless transmissions, for example to and from UE 115-e or AP 205-e.

I/O controller 1945 may manage input and output signals for device 1905. I/O controller 1945 may also manage peripherals not integrated into device 1905. In some cases, I/O controller 1945 may represent a physical connection or port to an external peripheral. In some cases, I/O controller 1945 may utilize an operating system such as iOS®, ANDROID®, MS-DOS®, MS-WINDOWS®, OS/2®, UNIX®, LINUX®, or another known operating system.

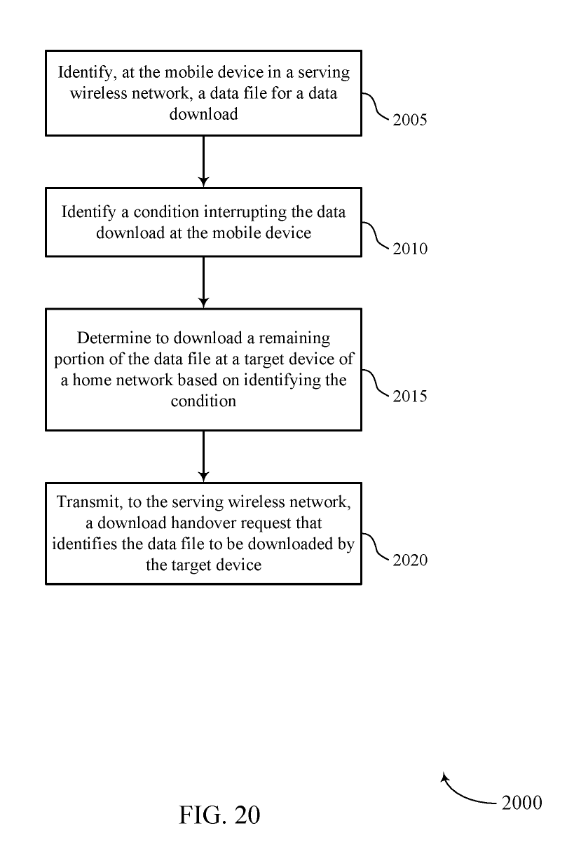

FIG. 20 shows a flowchart illustrating a method 2000 for data download handover from device to device in accordance with various aspects of the present disclosure. The operations of method 2000 may be implemented by a UE 115 or its components as described herein. For example, the operations of method 2000 may be performed by a UE communications manager as described with reference to FIGS. 8 through 11. In some examples, a UE 115 may execute a set of codes to control the functional elements of the device to perform the functions described below. Additionally or alternatively, the UE 115 may perform aspects the functions described below using special-purpose hardware.

At block 2005 the UE 115 may identify, at the mobile device in a serving wireless network, a data file for a data download. The operations of block 2005 may be performed according to the methods described with reference to FIGS. 1 through 7. In certain examples, aspects of the operations of block 2005 may be performed by a data downloader as described with reference to FIGS. 8 through 11.

At block 2010 the UE 115 may identify a condition interrupting the data download at the mobile device. The operations of block 2010 may be performed according to the methods described with reference to FIGS. 1 through 7. In certain examples, aspects of the operations of block 2010 may be performed by a condition monitor as described with reference to FIGS. 8 through 11.

At block 2015 the UE 115 may determine to download a remaining portion of the data file at a target device of a home network based at least in part on identifying the condition. In some cases, the remaining portion of the data file may include the complete data file. The operations of block 2015 may be performed according to the methods described with reference to FIGS. 1 through 7. In certain examples, aspects of the operations of block 2015 may be performed by a download handover manager as described with reference to FIGS. 8 through 11.

At block 2020 the UE 115 may transmit, to the serving wireless network, a download handover request that identifies the data file to be downloaded by the target device. The operations of block 2020 may be performed according to the methods described with reference to FIGS. 1 through 7. In certain examples, aspects of the operations of block 2020 may be performed by a download handover request component as described with reference to FIGS. 8 through 11.

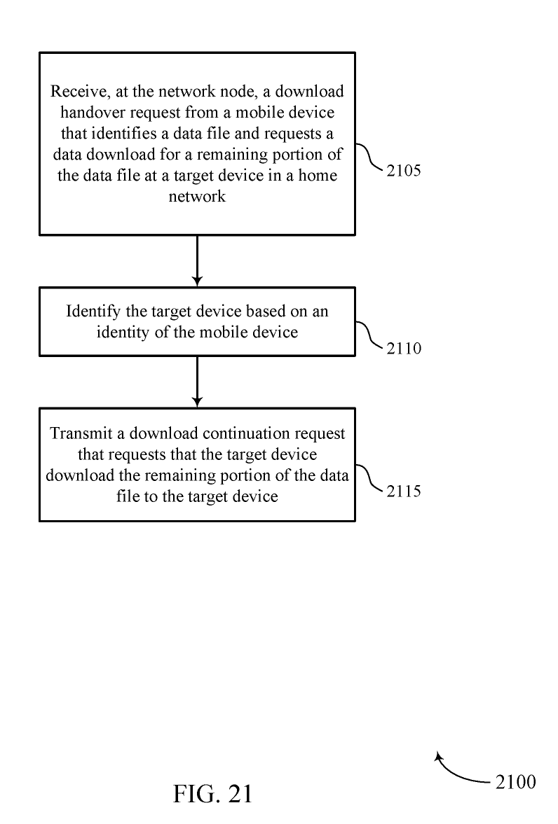

FIG. 21 shows a flowchart illustrating a method 2100 for data download handover from device to device in accordance with various aspects of the present disclosure. The operations of method 2100 may be implemented by a base station 105 or its components as described herein. For example, the operations of method 2100 may be performed by a network node communications manager as described with reference to FIGS. 12 through 15. In some examples, a base station 105 may execute a set of codes to control the functional elements of the device to perform the functions described below. Additionally or alternatively, the base station 105 may perform aspects the functions described below using special-purpose hardware.

At block 2105 the base station 105 may receive, at the network node, a download handover request from a mobile device that identifies a data file and requests a data download for a remaining portion of the data file at a target device in a home network. The operations of block 2105 may be performed according to the methods described with reference to FIGS. 1 through 7. In certain examples, aspects of the operations of block 2105 may be performed by a mobile device communication manager as described with reference to FIGS. 12 through 15.

At block 2110 the base station 105 may identify the target device based at least in part on an identity of the mobile device. The operations of block 2110 may be performed according to the methods described with reference to FIGS. 1 through 7. In certain examples, aspects of the operations of block 2110 may be performed by a target device identifier as described with reference to FIGS. 12 through 15.

At block 2115 the base station 105 may transmit a download continuation request that requests that the target device download the remaining portion of the data file to the target device. The operations of block 2115 may be performed according to the methods described with reference to FIGS. 1 through 7. In certain examples, aspects of the operations of block 2115 may be performed by a target device communication manager as described with reference to FIGS. 12 through 15.

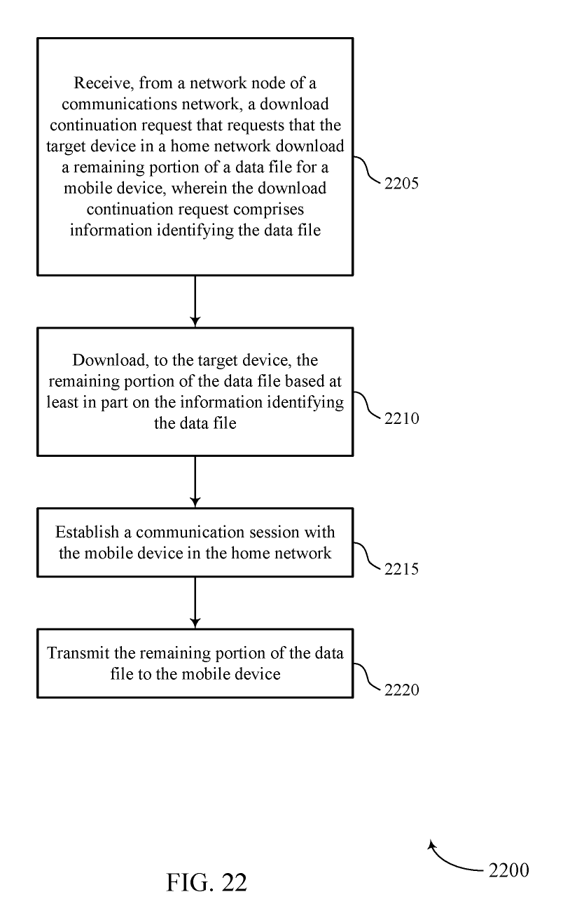

FIG. 22 shows a flowchart illustrating a method 2200 for data download handover from device to device in accordance with various aspects of the present disclosure. The operations of method 2200 may be implemented by a STA 215 or its components as described herein. For example, the operations of method 2200 may be performed by a STA communications manager as described with reference to FIGS. 16 through 19. In some examples, a STA 215 may execute a set of codes to control the functional elements of the device to perform the functions described below. Additionally or alternatively, the STA 215 may perform aspects the functions described below using special-purpose hardware.

At block 2205 the STA 215 may receive, from a network node of a communications network, a download continuation request that requests that the target device in a home network download a remaining portion of a data file for a mobile device, wherein the download continuation request comprises information identifying the data file. The operations of block 2205 may be performed according to the methods described with reference to FIGS. 1 through 7. In certain examples, aspects of the operations of block 2205 may be performed by a network node communications manager as described with reference to FIGS. 16 through 19.

At block 2210 the STA 215 may download, to the target device, the remaining portion of the data file based at least in part on the information identifying the data file. The operations of block 2210 may be performed according to the methods described with reference to FIGS. 1 through 7. In certain examples, aspects of the operations of block 2210 may be performed by a data downloader as described with reference to FIGS. 16 through 19.

At block 2215 the STA 215 may establish a communication session with the mobile device in the home network. The operations of block 2215 may be performed according to the methods described with reference to FIGS. 1 through 7. In certain examples, aspects of the operations of block 2215 may be performed by a mobile device communication manager as described with reference to FIGS. 16 through 19.

At block 2220 the STA 215 may transmit the remaining portion of the data file to the mobile device. The operations of block 2220 may be performed according to the methods described with reference to FIGS. 1 through 7. In certain examples, aspects of the operations of block 2220 may be performed by a mobile device communication manager as described with reference to FIGS. 16 through 19.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are releases of Universal Mobile Telecommunications System (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communication system 100 and WLAN 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication at a mobile device, comprising:
a memory that stores instructions; and
a processor coupled with the memory, wherein the processor and the memory are configured to:
identify, at the mobile device in a serving wireless network, a data file for a data download;
identify a condition interrupting the data download at the mobile device;
determine to download a remaining portion of the data file at a target device of a home network based at least in part on the identified condition; and
transmit, to the serving wireless network, a download handover request that identifies the data file to be downloaded by the target device.

2. The apparatus of claim 1, wherein the processor and the memory are further configured to:
establish a communication session with the target device in the home network; and
receive the remaining portion of the data file from the target device.

3. The apparatus of claim 1, wherein the remaining portion of the data file comprises a complete data file.

4. The apparatus of claim 1, wherein the processor and the memory are further configured to:
select, from among a set of target devices, the target device to download the remaining portion of the data file.

5. The apparatus of claim 1, wherein the processor and the memory are further configured to:
identify one or more target devices to receive download handovers in the home network for the mobile device, wherein the one or more target devices comprise the target device; and
transmit, to the serving wireless network, a registration request for the serving wireless network to associate the mobile device with the one or more target devices.

6. The apparatus of claim 5, wherein the processor and the memory are further configured to:
assign a priority to each of the respective one or more target devices, wherein the registration request further comprises the assigned priorities.

7. The apparatus of claim 1, wherein the processor and the memory configured to identify the condition interrupting the data download by being configured to:
receive a user command for the mobile device to perform a download handover; or
determine that an amount of data used by the mobile device has exceeded a predetermined data usage threshold; or
determine that an amount of available storage of the mobile device has fallen below a predetermined storage threshold; or
determine that a transmission capacity for the mobile device has fallen below a predetermined capacity threshold; or
determine that a shutdown procedure for the mobile device has been initiated; or
determine that a battery level of the mobile device is less than a predetermined battery level threshold; or
a combination thereof.

8. The apparatus of claim 1, wherein the processor and the memory are further configured to:
transmit the download handover request in a radio resource control (RRC) message to the serving wireless network.

9. The apparatus of claim 1, wherein the apparatus is a wireless communication terminal and further comprises an antenna and a transceiver.

10. The apparatus of claim 1, wherein:
the serving wireless network comprises a wireless wide area network (WWAN); and
the home network comprises a wireless local area network (WLAN) or a WWAN.

11. An apparatus for wireless communication at a target device, comprising:
a memory that stores instructions; and
a processor coupled with the memory, wherein the processor and the memory are configured to:
receive, from a network node of a communications network, a download continuation request that requests that the target device in a home network download a remaining portion of a data file for a mobile device, wherein the download continuation request comprises information identifying the data file;
download, to the target device, the remaining portion of the data file based at least in part on the information identifying the data file;
establish a communication session with the mobile device in the home network; and
transmit the remaining portion of the data file to the mobile device.

12. The apparatus of claim 11, wherein the processor and the memory are further configured to:
transmit, to the network node, a request to transmit the remaining portion of the data file based at least in part on receiving the download continuation request; and
download the remaining portion of the data file from the network node.

13. The apparatus of claim 11, wherein the download continuation request comprises a download handover paging message.

14. The apparatus of claim 13, wherein the download handover paging message comprises metadata associated with the data file.

15. The apparatus of claim 11, wherein the processor and the memory are configured to establish the communication session with the mobile device by being configured to:
establish a wireless peer-to-peer file transfer session between the mobile device and the target device.

16. The apparatus of claim 11, wherein the apparatus is a wireless communication terminal and further comprises an antenna and a transceiver.

17. A method for wireless communication at a mobile device, comprising:
identifying, at the mobile device in a serving wireless network, a data file for a data download;
identifying a condition interrupting the data download at the mobile device;
determining to download a remaining portion of the data file at a target device of a home network based at least in part on identifying the condition; and
transmitting, to the serving wireless network, a download handover request that identifies the data file to be downloaded by the target device.

18. The method of claim 1, further comprising:
establishing a communication session with the target device in the home network; and
receiving the remaining portion of the data file from the target device.

19. The method of claim 1, further comprising:
selecting, from among a set of target devices, the target device to download the remaining portion of the data file.

20. The method of claim 1, further comprising:
identifying one or more target devices to receive download handovers in the home network for the mobile device, wherein the one or more target devices comprise the target device; and
transmitting, to the serving wireless network, a registration request for the serving wireless network to associate the mobile device with the one or more target devices.
